(19) United States
(12) Patent Application Publication
(10) Pub. No.: US 2023/0186078 A1
(43) Pub. Date: Jun. 15, 2023

(54) System, Method, and Computer Program Product for Dynamic User Interfaces for RNN-Based Deep Reinforcement Machine-Learning Models

(71) Applicant: Visa International Service Association, San Francisco, CA (US)

(72) Inventors: Junpeng Wang, Sunnyvale, CA (US); Wei Zhang, Fremont, CA (US); Hao Yang, San Jose, CA (US); Michael Yeh, Newark, CA (US); Liang Wang, San Jose, CA (US)

(21) Appl. No.: 17/912,070

(22) PCT Filed: Apr. 30, 2021
(86) PCT No.: PCT/IB21/53632

§ 371 Date: Sep. 16, 2022

Related U.S. Application Data
(60) Provisional application No. 63/017,907, filed on Apr. 30, 2020.

(51) Int. Cl. G06N 3/08; G06T 11/20; G06Q 20/40

(52) U.S. Cl. CPC G06N 3/08; G06T 11/206; G06Q 20/4016; G06T 2200/24

(57) ABSTRACT

A method for evaluating a RNN-based deep learning model includes: receiving model data generated by the RNN-based model, the model data including a plurality of events associated with a plurality of states; generating a first GUI based on the events and states including a chart visually representing a timeline for the events in relation to a parameter value; generating a second GUI including a point chart visually representing a two-dimensional projection of the multi-dimensional intermediate data, each point of the point chart representing a time step and an event from the time step, based on multi-dimensional intermediate data between transformations in the model that connect a state to an event; and perturbing the environment at a time step based on user interaction with at least one of the first and second GUIs.

### CROSS REFERENCE TO RELATED APPLICATIONS

This application is the United States national phase of International Application No. PCT/IB2021/053632 filed Apr. 30, 2021 and claims priority to U.S. Provisional Patent Application No. 63/017,907, filed Apr. 30, 2020, the disclosures of which are incorporated herein by reference in their entirety.

### BACKGROUND

### 1. Technical Field

This disclosure relates generally to dynamic user interfaces for use in machine-learning and, in particular embodiments, to a system, method and computer program product for dynamic user interfaces for RNN-based deep reinforcement machine-learning models.

### 2. Technical Considerations

Deep reinforcement learning targets to train an autonomous agent to interact with a pre-defined environment and strive to achieve specific goals through deep neural networks (DNN). Recurrent neural network (RNN)-based deep learning models are beneficial because RNN-based models can effectively capture the temporal evolution of the environment and respond with proper agent actions. However, even in view of these performance benefits, there is more to understand with respect to how the RNN-based models understand the environment internally and what the model memorizes over time. These details are extremely important for domain experts to understand the models and to further improve them, which is technically complicated due to the high-dimensional internal data representations of such models.

### SUMMARY

According to some non-limiting embodiments or aspects, a computer-implemented method for evaluating a recurrent neural network (RNN)-based deep learning model, includes: generating, with the at least one processor, a first graphical user interface (GUI) based on model data generated by a RNN-based deep learning model, the model data comprising a plurality of events associated with a plurality of states in an environment, the first GUI including a chart visually representing a timeline for the plurality of events in relation to at least one parameter value based on the plurality of events and the plurality of states; generating, with the at least one processor, a second GUI including a point chart visually representing a two-dimensional projection of the multi-dimensional intermediate data, each point of the point chart representing a time step and at least one event from the time step, based on multi-dimensional intermediate data between transformations in the RNN-based deep learning model that connect at least one state of the plurality of states to at least one event of the plurality of events; and perturbing, with the at least one processor, the environment at a time step based on user interaction with at least one of the first GUI and the second GUI.

In non-limiting embodiments or aspects, the computer-implemented method may further include generating, with the at least one processor, a third GUI based on at least one hidden state and/or cell state of the RNN-based deep learning model. The computer-implemented method may further include identifying, with the at least one processor, a hidden state and/or cell state from the at least one hidden state and/or cell state impacting an event of the plurality of events. Generating the third GUI includes generating a visual representation of contrasted distributions over different subsets of a plurality of steps. Generating the third GUI may include generating at least two rows including a plurality of visual representations on each row, each visual representation of the plurality of visual representations visualizing a hidden state and/or a cell state for one dimension of a plurality of dimensions of the model, where a first row of the at least two rows visually represents static global information of the plurality of steps, and where a second row of the at least two rows visually represents local information of a single step associated with the first GUI. The first GUI and second GUI may include different windows within the same primary GUI.

In non-limiting embodiments or aspects, the computer-implemented method may further include updating, with the at least one processor, at least one of the first GUI and the second GUI based on output resulting from perturbing the environment. The computer-implemented method may further include determining at least one predicted rule generated by the RNN-based deep learning model based on data underlying the first and/or second GUI, where the at least one predicted rule includes at least one condition and at least one predicted response to the at least one condition; and verifying that the RNN-based deep learning model implements the at least one predicted rule by perturbing the environment based on the at least one condition; and analyzing a response of the RNN-based deep learning model to the perturbation based on the at least one predicted response. The computer-implemented method may further include training, with the at least one processor, a second deep learning model using the RNN-based deep learning model. The environment may include a simulated event, and the plurality of events and the plurality of states are associated with the simulated event. The simulated event may include a simulated electronic payment fraud determination event. Perturbing the environment may include submitting a simulated electronic payment transaction to the RNN-based deep learning model.

In non-limiting embodiments or aspects, the environment may include an electronic payment processing network, and the plurality of events may include a plurality of transactions associated with transaction data, and each state of the plurality of states may include at least one of the following: a plurality of fraud determinations, a plurality of charge-backs, a plurality of cross-border transactions, or any combination thereof. The model data may be generated based on historical transaction data, further including: extracting at least one rule generated by the RNN-based deep learning model; and applying the at least one rule to future transactions by a transaction processing system. The computer-implemented method may further include integrating the RNN-based deep learning model with a transaction processing system processing new transaction data associated with a new transaction by: evaluating the new transaction data with the RNN-based deep learning model; and determining the state of the new transaction with the RNN-based deep learning model. The computer-implemented method may further include denying the new transaction in response to determining the state of the new transaction to be a fraudulent state. The parameter value may relate to at least one effect of a plurality of effects or at least one state of the plurality of states. The RNN-based deep learning model may be based on the plurality of states, the plurality of events, and a plurality of rewards associated with at least one state of the plurality of states and/or an event of the plurality of events.

According to some non-limiting embodiments or aspects, a system for evaluating a recurrent neural network (RNN)-based deep learning model includes: at least one data storage device including model data generated by a RNN-based deep learning model, the model data including a plurality of events associated with a plurality of states in an environment; at least one processor in communication with the at least one data storage device, the at least one processor programmed or configured to: generate a first graphical user interface (GUI) based on model data generated by a RNN-based deep learning model, the model data comprising a plurality of events associated with a plurality of states in an environment, the first GUI including a chart visually representing a timeline for the plurality of events in relation to at least one parameter value based on the plurality of events and the plurality of states; generate a second GUI including a point chart visually representing a two-dimensional projection of the multi-dimensional intermediate data, each point of the point chart representing a time step and at least one event from the time step, based on multi-dimensional intermediate data between transformations in the RNN-based deep learning model that connect at least one state of the plurality of states to at least one event of the plurality of events; and perturb the environment at a time step based on user interaction with at least one of the first GUI and the second GUI.

In non-limiting embodiments or aspects, the environment may include a simulated event, and the plurality of events and the plurality of states are associated with the simulated event, the system may further include the RNN-based deep learning model, where the at least one processor may be programmed or configured to submit a simulated electronic payment transaction to the RNN-based deep learning model for a simulated fraud determination. The system may further include a transaction processing system in communication with at least one merchant system and at least one issuer system within an electronic payment processing network, where the transaction processing system may include the at least one processor, and where the at least one processor is further programmed or configured to evaluate new transaction data received by the transaction processing system with the RNN-based deep learning model.

According to some non-limiting embodiments or aspects, a computer program product for evaluating a recurrent neural network (RNN)-based deep learning model, includes at least one non-transitory computer-readable medium including program instructions that, when executed by at least one processor, cause the at least one processor to: generate a first graphical user interface (GUI) based on model data generated by a RNN-based deep learning model, the model data comprising a plurality of events associated with a plurality of states in an environment, the first GUI including a chart visually representing a timeline for the plurality of events in relation to at least one parameter value based on the plurality of events and the plurality of states; generate a second GUI including a point chart visually representing a two-dimensional projection of the multi-dimensional intermediate data, each point of the point chart representing a time step and at least one event from the time step, based on multi-dimensional intermediate data between transformations in the RNN-based deep learning model that connect at least one state of the plurality of states to at least one event of the plurality of events; and perturb the environment at a time step based on user interaction with at least one of the first GUI and the second GUI.

According to some non-limiting embodiments or aspects, a computer-implemented method for evaluating a recurrent neural network (RNN)-based deep learning model includes: generating, with the at least one processor, a first graphical user interface (GUI) based on model data generated by a RNN-based deep learning model, the model data comprising a plurality of events associated with a plurality of states in an environment, the first GUI including a chart visually representing a timeline for the plurality of events in relation to at least one parameter value based on the plurality of events and the plurality of states; generating, with the at least one processor, a second GUI including a point chart visually representing a two-dimensional projection of the multi-dimensional intermediate data, each point of the point chart representing a time step and at least one event from the time step, based on multi-dimensional intermediate data between transformations in the RNN-based deep learning model; and based on user input received through at least one of the first GUI and the second GUI, replaying at least one subset of consecutive time steps.

In non-limiting embodiments or aspects, the computer-implemented method may further include generating, with the at least one processor, a third GUI based on at least one hidden state and/or cell state of the RNN-based deep learning model. The computer-implemented method may further include identifying, with the at least one processor, a hidden state and/or cell state from the at least one hidden state and/or cell state impacting an event of the plurality of events. Generating the third GUI may include generating a visual representation of contrasted distributions over different subsets of a plurality of steps. Generating the third GUI may include generating at least two rows including a plurality of visual representations on each row, each visual representation of the plurality of visual representations visualizing a hidden state and/or a cell state for one dimension of a plurality of dimensions of the model, where a first row of the at least two rows visually represents static global information of the plurality of steps, and where a second row of the at least two rows visually represents local information of a single step associated with the first GUI. The first GUI and second GUI may include different windows within the same primary GUI.

In non-limiting embodiments or aspects, the computer-implemented method may further include: determining at least one predicted rule generated by the RNN-based deep learning model based on data underlying the first and/or second GUI, where the at least one predicted rule includes at least one condition and at least one predicted response to the at least one condition; and verifying that the RNN-based deep learning model implements the at least one predicted rule by replaying at least one first time step corresponding to the at least one condition; and analyzing a response of the RNN-based deep learning model after the at least one first time step based on the at least one predicted response. The computer-implemented method may further include training, with the at least one processor, a second deep learning model using the RNN-based deep learning model. The environment may include a simulated event, and the plurality of events and the plurality of states are associated with the simulated event. The simulated event may include a simulated electronic payment fraud determination event. The computer-implemented method may further include perturbing the environment by submitting a simulated electronic payment transaction to the RNN-based deep learning model.

In non-limiting embodiments or aspects, the environment may include an electronic payment processing network, where the plurality of events may include a plurality of transactions associated with transaction data, and where each state of the plurality of states may include at least one of the following: a plurality of fraud determinations, a plurality of charge-backs, a plurality of cross-border transactions, or any combination thereof. The model data may be generated based on historical transaction data, further including: extracting at least one rule generated by the RNN-based deep learning model; and applying the at least one rule to future transactions by a transaction processing system. The computer-implemented method may further include: integrating the RNN-based deep learning model with a transaction processing system processing new transaction data associated with a new transaction by: evaluating the new transaction data with the RNN-based deep learning model; and determining the state of the new transaction with the RNN-based deep learning model. The computer-implemented method may further include denying the new transaction in response to determining the state of the new transaction to be a fraudulent state. The parameter value may relate to at least one effect of a plurality of effects or at least one state of the plurality of states. The RNN-based deep learning model may be based on the plurality of states, the plurality of events, and a plurality of rewards associated with at least one state of the plurality of states and/or at least one event of the plurality of events. The computer-implemented method may further include perturbing, with the at least one processor, the environment at the at least one subset of consecutive time steps.

According to some non-limiting embodiments or aspects, a system for evaluating a recurrent neural network (RNN)-based deep learning model includes: at least one data storage device including model data generated by a RNN-based deep learning model, the model data including a plurality of events associated with a plurality of states in an environment; at least one processor in communication with the at least one data storage device, the at least one processor programmed or configured to: generate a first graphical user interface (GUI) based on model data generated by a RNN-based deep learning model, the model data comprising a plurality of events associated with a plurality of states in an environment, the first GUI including a chart visually representing a timeline for the plurality of events in relation to at least one parameter value based on the plurality of events and the plurality of states; generate a second GUI including a point chart visually representing a two-dimensional projection of the multi-dimensional intermediate data, each point of the point chart representing a time step and at least one event from the time step, based on multi-dimensional intermediate data between transformations in the RNN-based deep learning model; and based on user input received through at least one of the first GUI and the second GUI, replay at least one subset of consecutive time steps.

In non-limiting embodiments or aspects, the environment may include a simulated event, and the plurality of events and the plurality of states are associated with the simulated event; the system may further include the RNN-based deep learning model, where the at least one processor may be programmed or configured to submit a simulated electronic payment transaction to the RNN-based deep learning model for a simulated fraud determination. The system may further include a transaction processing system in communication with at least one merchant system and at least one issuer system within an electronic payment processing network, where the transaction processing system may include the at least one processor, and where the at least one processor is further programmed or configured to evaluate new transaction data received by the transaction processing system with the RNN-based deep learning model.

According to some non-limiting embodiments or aspects, a computer program product for evaluating a recurrent neural network (RNN)-based deep learning model includes at least one non-transitory computer-readable medium including program instructions that, when executed by at least one processor, cause the at least one processor to: generate a first graphical user interface (GUI) based on model data generated by a RNN-based deep learning model, the model data comprising a plurality of events associated with a plurality of states in an environment, the first GUI including a chart visually representing a timeline for the plurality of events in relation to at least one parameter value based on the plurality of events and the plurality of states; generate a second GUI including a point chart visually representing a two-dimensional projection of the multi-dimensional intermediate data, each point of the point chart representing a time step and at least one event from the time step, based on multi-dimensional intermediate data between transformations in the RNN-based deep learning model; and based on user input received through at least one of the first GUI and the second GUI, replay at least one subset of consecutive time steps.

According to some non-limiting embodiments or aspects, a computer-implemented method for evaluating a recurrent neural network (RNN)-based deep learning model includes: generating, with the at least one processor, a first graphical user interface (GUI) based on model data generated by a RNN-based deep learning model, the model data comprising a plurality of events associated with a plurality of states in an environment, the first GUI including a chart visually representing a timeline for the plurality of events in relation to at least one parameter value based on the plurality of events and the plurality of states; and generating, with the at least one processor, a second GUI including a first plurality of visual representations and a second plurality of visual representations, each visual representation representing at least one hidden state and/or a cell state for one dimension of a plurality of dimensions of the model based on at least one hidden state and/or cell state of the RNN-based deep learning model, where the first plurality of visual representations is based on static global information of the plurality of steps, and where the second plurality of visual representations is based on local information of a single step associated with the first GUI.

In non-limiting embodiments or aspects, the computer-implemented method may further include perturbing, with the at least one processor, the environment at a time step based on user input received through at least one of the first GUI and the second GUI. The computer-implemented method may further include identifying, with the at least one processor, a hidden state and/or cell state from the at least one hidden state and/or cell state impacting an event of the plurality of events. Generating the second GUI may include generating a visual representation of contrasted distributions over different subsets of a plurality of steps. The computer-implemented method may include generating, with the at least one processor, a third GUI based on multi-dimensional intermediate data between transformations in the RNN-based deep learning model that connect at least one state of the plurality of states to at least one event of the plurality of events, the third GUI including a point chart visually representing a two-dimensional projection of the multi-dimensional intermediate data, each point of the point chart representing a time step and at least one event from the time step. The first GUI and second GUI may include different windows within the same primary GUI.

In non-limiting embodiments or aspects, the computer-implemented method may include updating, with the at least one processor, at least one of the first GUI and the second GUI based on output resulting from perturbing the environment. The computer-implemented method may further include: determining at least one predicted rule generated by the RNN-based deep learning model based on data underlying the first and/or second GUI, where the at least one predicted rule includes at least one condition and at least one predicted response to the at least one condition; and verifying that the RNN-based deep learning model implements the at least one predicted rule by perturbing the environment based on the at least one condition; and analyzing a response of the RNN-based deep learning model to the perturbation based on the at least one predicted response. The computer-implemented method may further include training, with the at least one processor, a second deep learning model using the RNN-based deep learning model. The environment may include a simulated event, and the plurality of events and the plurality of states are associated with the simulated event. The simulated event may include a simulated electronic payment fraud determination event. Perturbing the environment may include submitting a simulated electronic payment transaction to the RNN-based deep learning model.

In non-limiting embodiments or aspects, the environment may include an electronic payment processing network, where the plurality of events may include a plurality of transactions associated with transaction data, and where each state of the plurality of states may include at least one of the following: a plurality of fraud determinations, a plurality of charge-backs, a plurality of cross-border transactions, or any combination thereof. The model data may be generated based on historical transaction data, further including: extracting at least one rule generated by the RNN-based deep learning model; and applying the at least one rule to future transactions by a transaction processing system. The computer-implemented method may further include: integrating the RNN-based deep learning model with a transaction processing system processing new transaction data associated with a new transaction by: evaluating the new transaction data with the RNN-based deep learning model; and determining the state of the new transaction with the RNN-based deep learning model. The computer-implemented method may further include denying the new transaction in response to determining the state of the new transaction to be a fraudulent state. The parameter value may relate to at least one effect of a plurality of effects or at least one state of the plurality of states. The RNN-based deep learning model may be based on the plurality of states, the plurality of events, and a plurality of rewards associated with at least one state of the plurality of states and/or at least one event of the plurality of events.

According to some non-limiting embodiments or aspects, a system for evaluating a recurrent neural network (RNN)-based deep learning model includes: at least one data storage device including model data generated by a RNN-based deep learning model, the model data including a plurality of events associated with a plurality of states in an environment; at least one processor in communication with the at least one data storage device, the at least one processor programmed or configured to: generate a first graphical user interface (GUI) based on model data generated by a RNN-based deep learning model, the model data comprising a plurality of events associated with a plurality of states in an environment, the first GUI including a chart visually representing a timeline for the plurality of events in relation to at least one parameter value based on the plurality of events and the plurality of states; and generate a second GUI including a first plurality of visual representations and a second plurality of visual representations, each visual representation representing at least one hidden state and/or a cell state for one dimension of a plurality of dimensions of the model, based on at least one hidden state and/or cell state of the RNN-based deep learning model, where the first plurality of visual representations is based on static global information of the plurality of steps, and where the second plurality of visual representations is based on local information of a single step associated with the first GUI.

In non-limiting embodiments or aspects, the environment may include a simulated event, and the plurality of events and the plurality of states are associated with the simulated event, the system may further include the RNN-based deep learning model, where the at least one processor may be programmed or configured to submit a simulated electronic payment transaction to the RNN-based deep learning model for a simulated fraud determination. The system may further include a transaction processing system in communication with at least one merchant system and at least one issuer system within an electronic payment processing network, where the transaction processing system may include the at least one processor, and where the at least one processor is further programmed or configured to evaluate new transaction data received by the transaction processing system with the RNN-based deep learning model.

According to some non-limiting embodiments or aspects, a computer program product for evaluating a recurrent neural network (RNN)-based deep learning model includes at least one non-transitory computer-readable medium including program instructions that, when executed by at least one processor, cause the at least one processor to: generate a first graphical user interface (GUI) based on model data generated by a RNN-based deep learning model, the model data comprising a plurality of events associated with a plurality of states in an environment, the first GUI including a chart visually representing a timeline for the plurality of events in relation to at least one parameter value based on the plurality of events and the plurality of states; and generate a second GUI including a first plurality of visual representations and a second plurality of visual representations, each visual representation representing at least one hidden state and/or a cell state for one dimension of a plurality of dimensions of the model, based on at least one hidden state and/or cell state of the RNN-based deep learning model, where the first plurality of visual representations is based on static global information of the plurality of steps, and where the second plurality of visual representations is based on local information of a single step associated with the first GUI.

Further non-limiting embodiments or aspects are set forth in the following numbered clauses:

Clause 1: A computer-implemented method for evaluating a recurrent neural network (RNN)-based deep learning model, comprising: generating, with the at least one processor, a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states; generating, with the at least one processor, a second GUI comprising a point chart visually representing a two-dimensional projection of the multi-dimensional intermediate data, each point of the point chart representing a time step and at least one event from the time step, based on multi-dimensional intermediate data between transformations in the RNN-based deep learning model that connect at least one state of the plurality of states to at least one event of the plurality of events; and perturbing, with the at least one processor, the environment at a time step based on user interaction with at least one of the first GUI and the second GUI.

Clause 2: The computer-implemented method of clause 1, further comprising: generating, with the at least one processor, a third GUI based on at least one hidden state and/or cell state of the RNN-based deep learning model.

Clause 3: The computer-implemented method of clause 1 or 2, further comprising: identifying, with the at least one processor, a hidden state and/or cell state from the at least one hidden state and/or cell state impacting an event of the plurality of events.

Clause 4: The computer-implemented method of any of clauses 1 to 3, wherein generating the third GUI comprises generating a visual representation of contrasted distributions over different subsets of a plurality of steps.

Clause 5: The computer-implemented method of any of clauses 1 to 4, wherein generating the third GUI comprises generating at least two rows including a plurality of visual representations on each row, each visual representation of the plurality of visual representations visualizing a hidden state and/or a cell state for one dimension of a plurality of dimensions of the model, wherein a first row of the at least two rows visually represents static global information of the plurality of steps, and wherein a second row of the at least two rows visually represents local information of a single step associated with the first GUI.

Clause 6: The computer-implemented method of any of clauses 1 to 5, wherein the first GUI and second GUI comprise different windows within the same primary GUI.

Clause 7: The computer-implemented method of any of clauses 1 to 6, further comprising: updating, with the at least one processor, at least one of the first GUI and the second GUI based on output resulting from perturbing the environment.

Clause 8: The computer-implemented method of any of clauses 1 to 7, further comprising: determining at least one predicted rule generated by the RNN-based deep learning model based on data underlying the first and/or second GUI, wherein the at least one predicted rule comprises at least one condition and at least one predicted response to the at least one condition; and verifying that the RNN-based deep learning model implements the at least one predicted rule by perturbing the environment based on the at least one condition; and analyzing a response of the RNN-based deep learning model to the perturbation based on the at least one predicted response.

Clause 9: The computer-implemented method of any of clauses 1 to 8, further comprising: training, with the at least one processor, a second deep learning model using the RNN-based deep learning model.

Clause 10: The computer-implemented method of any of clauses 1 to 9, wherein the environment comprises a simulator performing a simulated event, wherein the plurality of events and the plurality of states are associated with the simulated event.

Clause 11: The computer-implemented method of any of clauses 1 to 10, wherein the simulated event comprises a simulated electronic payment fraud determination event.

Clause 12: The computer-implemented method of any of clauses 1 to 11, wherein perturbing the environment comprises submitting a simulated electronic payment transaction to the RNN-based deep learning model.

Clause 13: The computer-implemented method of any of clauses 1 to 12, wherein the environment comprises an electronic payment processing network, wherein the plurality of events comprise a plurality of transactions associated with transaction data, and wherein each state of the plurality of states comprises at least one of the following: a plurality of fraud determinations, a plurality of charge-backs, a plurality of cross-border transactions, or any combination thereof.

Clause 14: The computer-implemented method of any of clauses 1 to 13, wherein the model data is generated based on historical transaction data, further comprising: extracting at least one rule generated by the RNN-based deep learning model; and applying the at least one rule to future transactions by a transaction processing system.

Clause 15: The computer-implemented method of any of clauses 1 to 14, further comprising: integrating the RNN-based deep learning model with a transaction processing system processing new transaction data associated with a new transaction by: evaluating the new transaction data with the RNN-based deep learning model; and determining the state of the new transaction with the RNN-based deep learning model.

Clause 16: The computer-implemented method of any of clauses 1 to 15, further comprising: denying the new transaction in response to determining the state of the new transaction to be a fraudulent state.

Clause 17: The computer-implemented method of any of clauses 1 to 16, wherein the parameter value represents at least one effect of a plurality of effects or at least one state of the plurality of states.

Clause 18: The computer-implemented method of any of clauses 1 to 17, wherein the RNN-based deep learning model is based on the plurality of states, the plurality of events, and a plurality of rewards associated with at least one state of the plurality of states and/or at least one event of the plurality of events.

Clause 19: A system for evaluating a recurrent neural network (RNN)-based deep learning model, comprising: at least one data storage device comprising model data generated by a RNN-based deep learning model, the model data comprising a plurality of events associated with a plurality of states in an environment; at least one processor in communication with the at least one data storage device, the at least one processor programmed or configured to: generate a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states; generate a second GUI comprising a point chart visually representing a two-dimensional projection of the multi-dimensional intermediate data, each point of the point chart representing a time step and at least one event from the time step, based on multi-dimensional intermediate data between transformations in the RNN-based deep learning model that connect at least one state of the plurality of states to at least one event of the plurality of events; and perturb the environment at a time step based on user interaction with at least one of the first GUI and the second GUI.

Clause 20: The system of clause 19, wherein the environment comprises a simulator performing a simulated event, wherein the plurality of events and the plurality of states are associated with the simulated event, and wherein the at least one processor is programmed or configured to submit a simulated electronic payment transaction to the RNN-based deep learning model for a simulated fraud determination.

Clause 21: The system of clause 19 or 20, further comprising: a transaction processing system in communication with at least one merchant system and at least one issuer system within an electronic payment processing network, wherein the transaction processing system comprises the at least one processor, and wherein the at least one processor is further programmed or configured to evaluate new transaction data received by the transaction processing system with the RNN-based deep learning model.

Clause 22: A computer program product for evaluating a RNN-based deep learning model, comprising at least one non-transitory computer-readable medium including program instructions that, when executed by at least one processor, cause the at least one processor to: generate a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states; generate a second GUI comprising a point chart visually representing a two-dimensional projection of the multi-dimensional intermediate data, each point of the point chart representing a time step and at least one event from the time step, based on multi-dimensional intermediate data between transformations in the RNN-based deep learning model that connect at least one state of the plurality of states to at least one event of the plurality of events; and perturb the environment at a time step based on user interaction with at least one of the first GUI and the second GUI.

Clause 23: A computer-implemented method for evaluating a recurrent neural network (RNN)-based deep learning model, comprising: generating, with the at least one processor, a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states; generating, with the at least one processor, a second GUI comprising a point chart visually representing a two-dimensional projection of the multi-dimensional intermediate data, each point of the point chart representing a time step and at least one event from the time step, based on multi-dimensional intermediate data between transformations in the RNN-based deep learning model; and based on user input received through at least one of the first GUI and the second GUI, replaying at least one subset of consecutive time steps.

Clause 24: The computer-implemented method of clause 23, further comprising: generating, with the at least one processor, a third GUI based on at least one hidden state and/or cell state of the RNN-based deep learning model.

Clause 25: The computer-implemented method of clause 23 or 24, further comprising: identifying, with the at least one processor a hidden state and/or cell state from the at least one hidden state and/or cell state impacting an event of the plurality of events.

Clause 26: The computer-implemented method of any of clauses 23 to 25, wherein generating the third GUI comprises generating a visual representation of contrasted distributions over different subsets of a plurality of steps.

Clause 27: The computer-implemented method of any of clauses 23 to 26, wherein generating the third GUI comprises generating at least two rows including a plurality of visual representations on each row, each visual representation of the plurality of visual representations visualizing a hidden state and/or a cell state for one dimension of a plurality of dimensions of the model, wherein a first row of the at least two rows visually represents static global information of the plurality of steps, and wherein a second row of the at least two rows visually represents local information of a single step associated with the first GUI.

Clause 28: The computer-implemented method of any of clauses 23 to 27, wherein the first GUI and second GUI comprise different windows within the same primary GUI.

Clause 29: The computer-implemented method of any of clauses 23 to 28, further comprising: determining at least one predicted rule generated by the RNN-based deep learning model based on data underlying the first and/or second GUI, wherein the at least one predicted rule comprises at least one condition and at least one predicted response to the at least one condition; and verifying that the RNN-based deep learning model implements the at least one predicted rule by replaying at least one first time step corresponding to the at least one condition; and analyzing a response of the RNN-based deep learning model after the at least one first time step based on the at least one predicted response.

Clause 30: The computer-implemented method of any of clauses 23 to 29, further comprising: training, with the at least one processor, a second deep learning model using the RNN-based deep learning model.

Clause 31: The computer-implemented method of any of clauses 23 to 30, wherein the environment comprises a simulator performing a simulated event, wherein the plurality of events and the plurality of states are associated with the simulated event.

Clause 32: The computer-implemented method of any of clauses 23 to 31, wherein the simulated event comprises a simulated electronic payment fraud determination event.

Clause 33: The computer-implemented method of any of clauses 23 to 32, further comprising perturbing the environment by submitting a simulated electronic payment transaction to the RNN-based deep learning model.

Clause 34: The computer-implemented method of any of clauses 23 to 33, wherein the environment comprises an electronic payment processing network, wherein the plurality of events comprise a plurality of transactions associated with transaction data, and wherein each state of the plurality of states comprises at least one of the following: a plurality of fraud determinations, a plurality of charge-backs, a plurality of cross-border transactions, or any combination thereof.

Clause 35: The computer-implemented method of any of clauses 23 to 34, wherein the model data is generated based on historical transaction data, further comprising: extracting at least one rule generated by the RNN-based deep learning model; and applying the at least one rule to future transactions by a transaction processing system.

Clause 36: The computer-implemented method of any of clauses 23 to 35, further comprising: integrating the RNN-based deep learning model with a transaction processing system processing new transaction data associated with a new transaction by: evaluating the new transaction data with the RNN-based deep learning model; and determining the state of the new transaction with the RNN-based deep learning model.

Clause 37: The computer-implemented method of any of clauses 23 to 36, further comprising: denying the new transaction in response to determining the state of the new transaction to be a fraudulent state.

Clause 38: The computer-implemented method of any of clauses 23 to 37, wherein the parameter value represents at least one effect of a plurality of effects or at least one state of the plurality of states.

Clause 39: The computer-implemented method of any of clauses 23 to 38, wherein the RNN-based deep learning model is based on the plurality of states, the plurality of events, and a plurality of rewards associated with at least one state of the plurality of states and/or at least one event of the plurality of events.

Clause 40: The computer-implemented method of any of clauses 23 to 39, further comprising: perturbing, with the at least one processor, the environment at the at least one subset of consecutive time steps.

Clause 41: A system for evaluating a recurrent neural network (RNN)-based deep learning model, comprising: at least one data storage device comprising model data generated by a RNN-based deep learning model, the model data comprising a plurality of events associated with a plurality of states in an environment; at least one processor in communication with the at least one data storage device, the at least one processor programmed or configured to: generate a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states; generate a second GUI comprising a point chart visually representing a two-dimensional projection of the multi-dimensional intermediate data, each point of the point chart representing a time step and at least one event from the time step, based on multi-dimensional intermediate data between transformations in the RNN-based deep learning model; and based on user input received through at least one of the first GUI and the second GUI, replay at least one subset of consecutive time steps.

Clause 42: The system of clause 41, wherein the environment comprises a simulator performing a simulated event, wherein the plurality of events and the plurality of states are associated with the simulated event, and wherein the at least one processor is programmed or configured to submit a simulated electronic payment transaction to the RNN-based deep learning model for a simulated fraud determination.

Clause 43: The system of clause 41 or 42, further comprising: a transaction processing system in communication with at least one merchant system and at least one issuer system within an electronic payment processing network, wherein the transaction processing system comprises the at least one processor, and wherein the at least one processor is further programmed or configured to evaluate new transaction data received by the transaction processing system with the RNN-based deep learning model.

Clause 44: A computer program product for evaluating a recurrent neural network (RNN)-based deep learning model, comprising at least one non-transitory computer-readable medium including program instructions that, when executed by at least one processor, cause the at least one processor to: generate a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states; generate a second GUI comprising a point chart visually representing a two-dimensional projection of the multi-dimensional intermediate data, each point of the point chart representing a time step, and at least one event from the time step based on multi-dimensional intermediate data between transformations in the RNN-based deep learning model; and based on user input received through at least one of the first GUI and the second GUI, replay at least one subset of consecutive time steps.

Clause 45: A computer-implemented method for evaluating a recurrent neural network (RNN)-based deep learning model, comprising: generating, with the at least one processor, a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states; and generating, with the at least one processor, a second GUI comprising a first plurality of visual representations and a second plurality of visual representations, each visual representation representing at least one hidden state and/or a cell state for one dimension of a plurality of dimensions of the model, based on at least one hidden state and/or cell state of the RNN-based deep learning model, wherein the first plurality of visual representations is based on static global information of the plurality of steps, and wherein the second plurality of visual representations is based on local information of a single step associated with the first GUI.

Clause 46: The computer-implemented method of clause 45, further comprising: perturbing, with the at least one processor, the environment at a time step based on user input received through at least one of the first GUI and the second GUI.

Clause 47: The computer-implemented method of clause 45 or 46, further comprising: identifying, with the at least one processor, a hidden state and/or cell state from the at least one hidden state and/or cell state impacting an event of the plurality of events.

Clause 48: The computer-implemented method of any of clauses 45 to 47, wherein generating the second GUI comprises generating a visual representation of contrasted distributions over different subsets of a plurality of steps.

Clause 49: The computer-implemented method of any of clauses 45 to 48, further comprising: generating, with the at least one processor, a third GUI based on multi-dimensional intermediate data between transformations in the RNN-based deep learning model that connect at least one state of the plurality of states to at least one event of the plurality of events, the third GUI comprising a point chart visually representing a two-dimensional projection of the multi-dimensional intermediate data, each point of the point chart representing a time step and at least one event from the time step.

Clause 50: The computer-implemented method of any of clauses 45 to 49, wherein the first GUI and second GUI comprise different windows within the same primary GUI.

Clause 51: The computer-implemented method of any of clauses 45 to 50, further comprising: updating, with the at least one processor, at least one of the first GUI and the second GUI based on output resulting from perturbing the environment.

Clause 52: The computer-implemented method of any of clauses 45 to 51, further comprising: determining at least one predicted rule generated by the RNN-based deep learning model based on data underlying the first and/or second GUI, wherein the at least one predicted rule comprises at least one condition and at least one predicted response to the at least one condition; and verifying that the RNN-based deep learning model implements the at least one predicted rule by perturbing the environment based on the at least one condition; and analyzing a response of the RNN-based deep learning model to the perturbation based on the at least one predicted response.

Clause 53: The computer-implemented method of any of clauses 45 to 52, further comprising: training, with the at least one processor, a second deep learning model using the RNN-based deep learning model.

Clause 54: The computer-implemented method of any of clauses 45 to 53, wherein the environment comprises a simulator performing a simulated event, wherein the plurality of events and the plurality of states are associated with the simulated event.

Clause 55: The computer-implemented method of any of clauses 45 to 54, wherein the simulated event comprises a simulated electronic payment fraud determination event.

Clause 56: The computer-implemented method of any of clauses 45 to 55, wherein perturbing the environment comprises submitting a simulated electronic payment transaction to the RNN-based deep learning model.

Clause 57: The computer-implemented method of any of clauses 45 to 56, wherein the environment comprises an electronic payment processing network, wherein the plurality of events comprise a plurality of transactions associated with transaction data, and wherein each state of the plurality of states comprises at least one of the following: a plurality of fraud determinations, a plurality of charge-backs, a plurality of cross-border transactions, or any combination thereof.

Clause 58: The computer-implemented method of any of clauses 45 to 57, wherein the model data is generated based on historical transaction data, further comprising: extracting at least one rule generated by the RNN-based deep learning model; and applying the at least one rule to future transactions by a transaction processing system.

Clause 59: The computer-implemented method of any of clauses 45 to 58, further comprising: integrating the RNN-based deep learning model with a transaction processing system processing new transaction data associated with a new transaction by: evaluating the new transaction data with the RNN-based deep learning model; and determining the state of the new transaction with the RNN-based deep learning model.

Clause 60: The computer-implemented method of any of clauses 45 to 59, further comprising: denying the new transaction in response to determining the state of the new transaction to be a fraudulent state.

Clause 61: The computer-implemented method of any of clauses 45 to 60, wherein the parameter value represents at least one effect of a plurality of effects or at least one state of the plurality of states.

Clause 62: The computer-implemented method of any of clauses 45 to 61, wherein the RNN-based deep learning model is based on the plurality of states, the plurality of events, and a plurality of rewards associated with at least one state of the plurality of states and/or at least one event of the plurality of events.

Clause 63: A system for evaluating a recurrent neural network (RNN)-based deep learning model, comprising: at least one data storage device comprising model data generated by a RNN-based deep learning model, the model data comprising a plurality of events associated with a plurality of states in an environment; at least one processor in communication with the at least one data storage device, the at least one processor programmed or configured to: generate a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states; and generate a second GUI comprising a first plurality of visual representations and a second plurality of visual representations, each visual representation representing at least one hidden state and/or a cell state for one dimension of a plurality of dimensions of the model, based on at least one hidden state and/or cell state of the RNN-based deep learning model, wherein the first plurality of visual representations is based on static global information of the plurality of steps, and wherein the second plurality of visual representations is based on local information of a single step associated with the first GUI.

Clause 64: The system of clause 63, wherein the environment comprises a simulator performing a simulated event, wherein the plurality of events and the plurality of states are associated with the simulated event, and wherein the at least one processor is programmed or configured to submit a simulated electronic payment transaction to the RNN-based deep learning model for a simulated fraud determination.

Clause 65: The system of clause 63 or 64, further comprising: a transaction processing system in communication with at least one merchant system and at least one issuer system within an electronic payment processing network, wherein the transaction processing system comprises the at least one processor, and wherein the at least one processor is further programmed or configured to evaluate new transaction data received by the transaction processing system with the RNN-based deep learning model.

Clause 66: A computer program product for evaluating a recurrent neural network (RNN)-based deep learning model, comprising at least one non-transitory computer-readable medium including program instructions that, when executed by at least one processor, cause the at least one processor to: generate a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states; and generate a second GUI comprising a first plurality of visual representations and a second plurality of visual representations, each visual representation representing at least one hidden state and/or a cell state for one dimension of a plurality of dimensions of the model, based on at least one hidden state and/or cell state of the RNN-based deep learning model, wherein the first plurality of visual representations is based on static global information of the plurality of steps, and wherein the second plurality of visual representations is based on local information of a single step associated with the first GUI.

### BRIEF DESCRIPTION OF THE DRAWINGS

The patent or application file contains at least one drawing executed in color. Copies of this patent or patent application publication with color drawings will be provided by the Office upon request and payment of the necessary fee.

Additional advantages and details of the disclosure are explained in greater detail below with reference to the exemplary embodiments that are illustrated in the accompanying schematic figures, in which:

FIG. 1 shows a schematic diagram of a system for providing dynamic user interfaces for recurrent neural network (RNN)-based deep learning models according to some non-limiting embodiments or aspects;

FIG. 2 shows a schematic diagram of a system for providing dynamic user interfaces for RNN-based deep learning models in connection with an electronic payment processing network according to some non-limiting embodiments or aspects;

FIG. 3 shows a schematic diagram of a model system integrated with an electronic payment processing network according to some non-limiting embodiments or aspects;

FIG. 4 shows a schematic diagram of a RNN-based deep learning model;

FIG. 5 shows a schematic diagram of a system involving interaction of a plurality of machine learning models according to some non-limiting embodiments or aspects;

FIG. 6 shows a step diagram of a computer-implemented method for evaluating a RNN-based deep learning model according to some non-limiting embodiments or aspects;

FIG. 7 shows a step diagram of a computer-implemented method for evaluating a RNN-based deep learning model according to some non-limiting embodiments or aspects;

FIG. 8 shows a step diagram of a computer-implemented method for evaluating a RNN-based deep learning model according to some non-limiting embodiments or aspects;

FIG. 9 shows a diagram of one or more components, devices, and/or systems according to some non-limiting embodiments or aspects;

FIG. 10 shows a graphical user interface for evaluating a RNN-based deep learning model according to some non-limiting embodiments or aspects;

FIG. 11 shows a graphical user interface for evaluating a RNN-based deep learning model according to some non-limiting embodiments or aspects;

FIG. 12 shows a system in which an agent interacts with a game environment using a RNN-based deep learning model according to some non-limiting embodiments or aspects;

FIG. 13 shows a system diagram of an architecture and data flow for a RNN-based deep learning model according to some non-limiting embodiments or aspects;

FIG. 14 shows a system diagram for evaluating a RNN-based deep learning model according to some non-limiting embodiments or aspects;

FIG. 15 shows a graphical user interface associated with episode view according to some non-limiting embodiments or aspects;

FIG. 16 shows a graphical user interface associated with projection view according to some non-limiting embodiments or aspects;

FIG. 17 shows a graphical user interface associated with projection view illustrating four different playing strategies according to some non-limiting embodiments or aspects;

FIG. 18 shows a graphical user interface for further analyzing at least one of the playing strategies illustrated in FIG. 17 according to some non-limiting embodiments or aspects;

FIG. 19 shows a graphical user interface associated with dimension view according to some non-limiting embodiments or aspects;

FIG. 20 shows a graphical user interface associated with dimension view according to some non-limiting embodiments or aspects;

FIG. 21 shows a graphical user interface associated with dimension view according to some non-limiting embodiments or aspects; and

FIG. 22 shows a graphical user interface of important hidden/cell state dimensions identified using dimension view according to some non-limiting embodiments or aspects.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

The term “account data,” as used herein, refers to any data concerning one or more accounts for one or more users. Account data may include, for example, one or more account identifiers, user identifiers, transaction histories, balances, credit limits, issuer institution identifiers, and/or the like.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more databases such that they can be used to conduct a transaction without directly using the original account identifier. In some examples, an original account identifier, such as a PAN, may be associated with a plurality of tokens for different individuals or purposes.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the term “computing device” may refer to one or more electronic devices that are configured to directly or indirectly communicate with or over one or more networks. A computing device may be a mobile device, a desktop computer, and/or any other like device. Furthermore, the term “computer” may refer to any computing device that includes the necessary components to receive, process, and output data, and normally includes a display, a processor, a memory, an input device, and a network interface. As used herein, the term “server” may refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, such as POS devices, directly or indirectly communicating in the network environment may constitute a “system,” such as a merchant's POS system.

As used herein, the term “graphical user interface” (GUI) refers to a generated display, such as one or more displays with which a user may interact, either directly or indirectly (e.g., through a keyboard, mouse, touchscreen, etc.).

As used herein, the term “issuer institution” may refer to one or more entities, such as a bank, that provide accounts to customers for conducting payment transactions, such as initiating credit and/or debit payments. For example, an issuer institution may provide an account identifier, such as a PAN, to a customer that uniquely identifies one or more accounts associated with that customer. The account identifier may be embodied on a physical financial instrument, such as a payment card, and/or may be electronic and used for electronic payments. An issuer institution may be associated with a bank identification number or other unique identifier that uniquely identifies it among other issuer institutions. The terms “issuer institution,” “issuer bank,” and “issuer system” may also refer to one or more computer systems operated by or on behalf of an issuer institution, such as a server computer executing one or more software applications. For example, an issuer system may include one or more authorization servers for authorizing a payment transaction.

As used herein, the term “machine learning model” may refer to a set of programmatic (e.g., software) routines and parameters configured to predict one or more outputs of a real-world process (e.g., identification of a fraudulent payment transaction or the like) based on a set of input features. A structure of the programmatic routines (e.g., number of subroutines and relation between them) and/or the values of the parameters can be determined in a training process, which can use actual results of the real-world process that is being modeled.

As used herein, the term “merchant” may refer to an individual or entity that provides goods and/or services, or access to goods and/or services, to customers based on a transaction, such as a payment transaction. The term “merchant” or “merchant system” may also refer to one or more computer systems operated by or on behalf of a merchant, such as a server computer executing one or more software applications. A “point-of-sale (POS) system,” as used herein, may refer to one or more computers and/or peripheral devices used by a merchant to engage in payment transactions with customers, including one or more card readers, near-field communication (NFC) receivers, RFID receivers, and/or other contactless transceivers or receivers, contact-based receivers, payment terminals, computers, servers, input devices, and/or other like devices that can be used to initiate a payment transaction.

As used herein, the term “payment device” may refer to an electronic payment device, a portable financial device, a payment card (e.g., a credit or debit card), a gift card, a smartcard, smart media, a payroll card, a healthcare card, a wrist band, a machine-readable medium containing account information, a keychain device or fob, an RFID transponder, a retailer discount or loyalty card, a cellular phone, an electronic wallet mobile application, a personal digital assistant (PDA), a pager, a security card, a computer, an access card, a wireless terminal, a transponder, and/or the like. In some non-limiting embodiments, the payment device may include volatile or non-volatile memory to store information (e.g., an account identifier, a name of the account holder, and/or the like).

The term “processor,” as used herein, may represent any type of processing unit, such as a single processor having one or more cores, one or more cores of one or more processors, multiple processors each having one or more cores, and/or other arrangements and combinations of processing units. Reference to “at least one processor” can refer to a previously-recited processor or a different processor.

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.” Reference to “a server,” “the server,” “at least one processor,” or “the at least one processor,” or the like, as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “transaction service provider” may refer to an entity that receives transaction authorization requests from merchants or other entities and provides guarantees of payment, in some cases through an agreement between the transaction service provider and an issuer institution. The terms “transaction service provider” and “transaction processing system” may also refer to one or more computer systems operated by or on behalf of a transaction service provider, such as a transaction processing server executing one or more software applications. A transaction processing server may include one or more processors and, in some non-limiting embodiments, may be operated by or on behalf of a transaction service provider.

Non-limiting embodiments or aspects described herein are directed to a system, method, and computer program product for evaluating a recurrent neural network (RNN)-based deep learning model (e.g., a machine learning model). Non-limiting embodiments or aspects enable a user to interact with an environment and a RNN-based deep learning model to better understand how the RNN-based model understands the environment internally and what the model memorizes over time. Graphical user interfaces (GUIs) are generated which enable the user to interact with the system to evaluate the RNN-based model. The GUIs may enable the user to perturb the environment, replay consecutive steps taken by the RNN-based model in the environment, analyze hidden states and/or cell states considered by the RNN-based model, and other like activities useful for evaluating the RNN-based model. Non-limiting embodiments or aspects enable evaluation of RNN-based models in handling simulated events that have practical implementations in real-world events, such as in payment fraud determinations, charge-back predictions, cross-border transaction predictions, and the like. Non-limiting embodiments or aspects implement such RNN-based models in real-world situations, such as integrating the model system as a component in an electronic payment processing network.

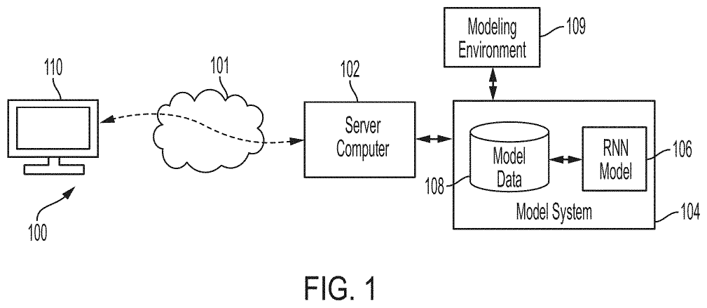

Referring now to FIG. 1, a system 100 for evaluating a RNN-based deep learning model and/or providing dynamic user interfaces for RNN-based deep learning models is shown according to some non-limiting embodiments or aspects. A computing device 110 may be in communication with a server computer 102 via a network environment 101, such as the Internet or a private network. The server computer 102 may be in communication with a data storage device including a model system 104 comprising model data 108 and a RNN-based deep learning model (RNN model) 106. The RNN model 106 may generate and store model data 108 by processing one or more inputs. The model system 104 may be in communication with a modeling environment 109, which may include one or more systems, devices, and/or software applications that output data to be modeled (as input to the RNN model 106), and/or may include a simulator for performing a simulated event.

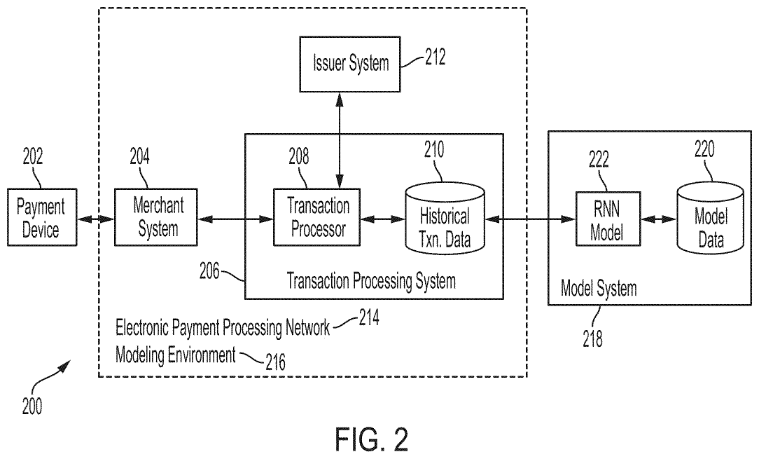

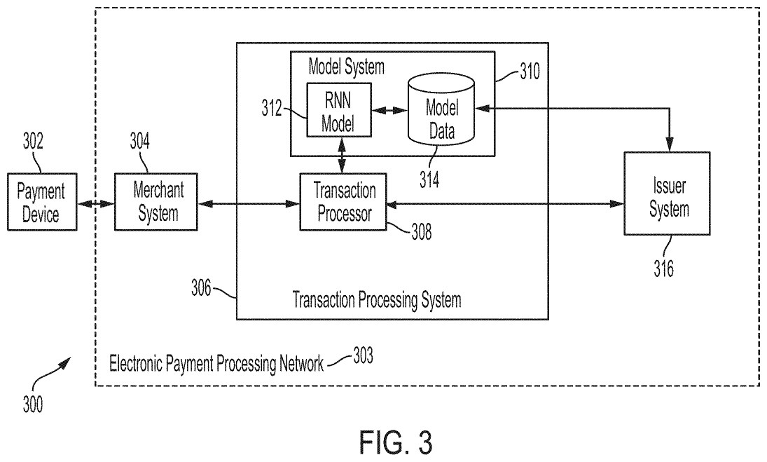

As an example, the modeling environment 109 may include an electronic payment processing network including a transaction processing system and one or more issuer systems for approving an electronic payment transaction initiated by a user (see e.g., FIGS. 2-3). As another example, the modeling environment 109 may include an interactive game played by a user and/or any other type of software and/or hardware environment in which a user performs actions (e.g., events) that may result in an output (e.g., states and/or rewards). The events may include, for example, steps performed by the user, by the computing device 110, and/or a combination of the user and computing device 110. The states may include, for example, a change in a variable value (e.g., a number of points, a fraud determination, a fraud score, an authorization determination, an authentication determination, a cross-border transaction prediction, etc.), a change in appearance of a GUI, and/or the like.

With continued reference to FIG. 1, the computing device 110 may generate and display at least one GUI based on data received from the server computer 102. The GUI may include one or more different windows (e.g., a first GUI, a second GUI, a third GUI, etc.) within a primary GUI or as separate GUIs. The GUI may include an episode GUI, a projection GUI, and/or a dimensions GUI, as further described hereinafter, that are generated based on the model data 108.

For example, once an RNN model 106 has been executed with respect to a modeling environment 109, the generated model data 108 may include a series of steps where each step includes at least one event and at least one state. The steps may be arranged as time steps over a plurality of time intervals. The server computer 102 may process this model data 108 and communicate data configured to display the GUI(s) on the computing device 110. The user of the computing device 110 may interact with the GUI to choose specific time steps, dimensions, and/or other aspects of the model data 108 to focus on that portion of the RNN model 106. The GUI may be modified and updated based on the user's interactions. In this manner, a user of the computing device 110 is enabled to explore, understand, and diagnose the RNN model 106 with respect to the modeling environment 109, including cell states and/or hidden states that may be used as intermediate data that is passed between nodes/layers of the model. In a Long Short Term Memory (LSTM) RNN-based model, for example, the GUI may provide a visualization of hidden states.

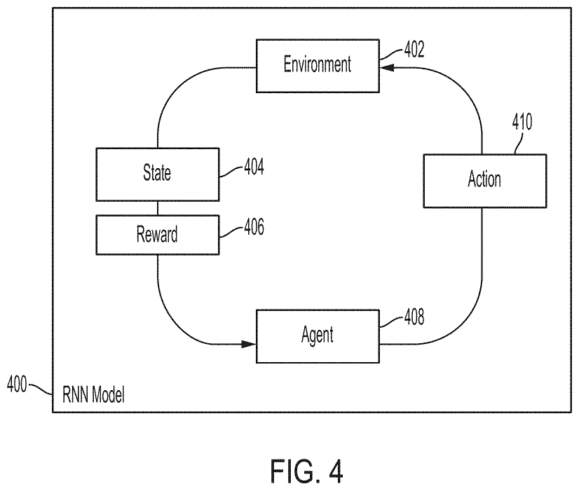

Referring to FIG. 4, an RNN model 400 is shown according to some non-limiting embodiments or aspects. The RNN model 400 may simulate an event and include an agent 408 interacting with an environment 402, such as the previously described modeling environment. The environment 402 may be an environment associated with a simulated event. The environment 402 may have an associated state 404 associated with at least one characteristic of the environment 402. The state 404 may be an input to the agent 408 which generates an action 410 based at least in part on analyzing the state 404. The action 410 is an input to the environment 402, which in turn generates the next state 404 and any associated reward 406 associated with the agent's 408 action 410. As such, the RNN model 400 may be based on the states 404, actions (events) 410, and rewards 406 associated with at least one of the states 404 and actions 410. The simulated event involving the environment 402 and the agent 408 of the RNN model 400 may run until completion of the simulated event.

As one non-limiting example of the features of FIG. 4, the event being simulated may include an electronic payment transaction initiated between a user and a merchant using the user's payment device, with the environment 402 including the electronic payment processing network. The state 404 may include various characteristics of the environment 402 and the payment transaction. Such characteristics may include transaction data provided in the processing of electronic payment transactions, such as user account data, merchant data, circumstances of the payment transaction (e.g., time of day, card-not-present or card-present, location data, and the like), or any other data relevant to the payment transaction. The action 410 may include a determination made by the agent 408 regarding the payment transaction, such as a fraud determination generated by the agent 408, such as that the transaction is fraudulent or non-fraudulent, and/or a fraud score indicating a likelihood that the action is fraudulent. The fraud score may be in any format, such a numerical score, a letter grade, or the like. The reward 406 may include a verification that the agent's 408 action 410 identifying the payment transaction as fraudulent or non-fraudulent was confirmed to be correct or determined to be incorrect. It will be appreciated that other simulated events may include different environments 402, states 404, rewards 406, agents 408 and actions 410 depending on the parameters of the simulated event.

In another non-limiting example of the features of FIG. 4, the event being simulated may include a video game played between a computer and the RNN model. In this example, the environment 402 may be the game, and the state 404 may be characteristics associated with the current layout of the game, such as locations of various components and/or rules associated with the game. The action 410 may be the action taken by the RNN model at the particular stage of the game, such as an active or passive response to the current state 404. The reward 406 may be points awarded or deducted as dictated by the rules of the game or a positive or negative outcome resulting from the action 410 (e.g., a win or loss of the game or a subset of the game). The various states 404, rewards 406, actions 410 and other generated data associated with the simulated event may be stored as model data.

Referring again to FIG. 1, in some non-limiting embodiments or aspects, the server computer 102 may receive the model data 108 generated by the RNN model 106 based on interaction with the modeling environment 109 and may communicate the model data 108 over the network environment 101 to the computing device 110. This model data 108 may include a plurality of events (e.g., the actions 410 described in FIG. 4) associated with a plurality of states in the modeling environment 109.

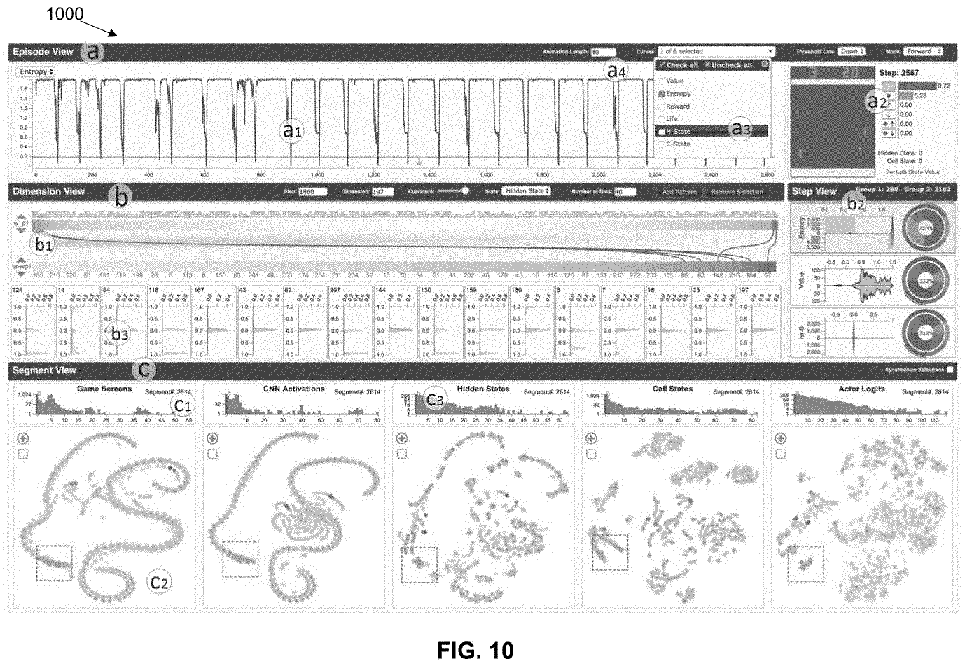

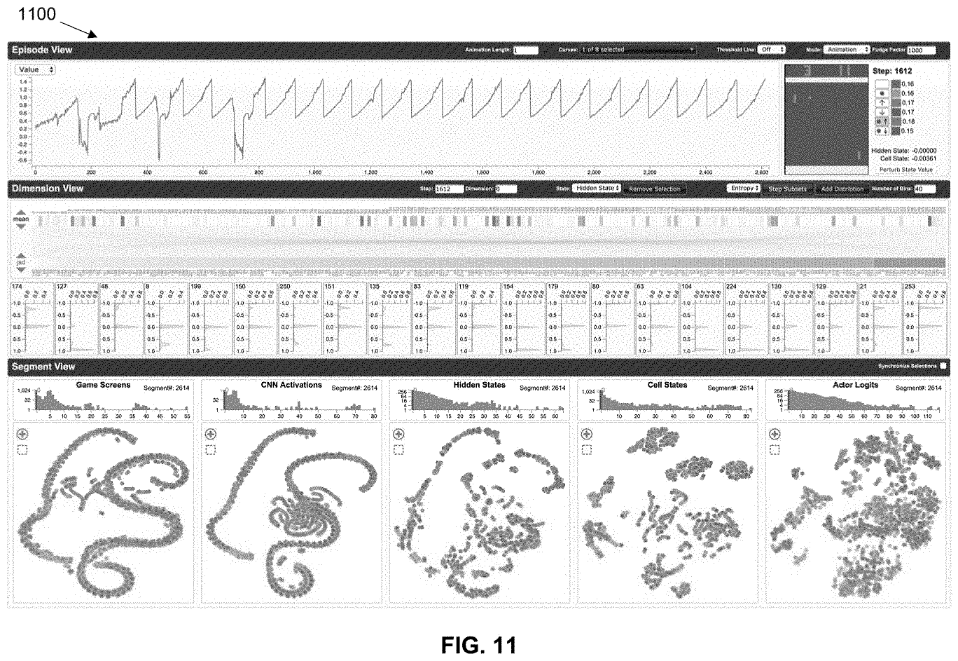

From the model data 108 (and the plurality of events and states associated therewith), the computing device 110 may generate and display at least one GUI. The computing device may generate a plurality of GUIs, such as 2-3 GUIs, which each display the model data 108, including data derived from the model data 108, using a different format. The plurality of GUIs may be separate windows or sub-windows of the same primary GUI (see e.g., FIGS. 10 and 11).

With continued reference to FIG. 1, in some non-limiting embodiments or aspects, from the model data 108, the computing device 110 may generate a first GUI, hereinafter referred to as an “Episode View GUI”. Non-limiting examples of Episode View GUIs in the environment described in the Examples are shown in FIGS. 10a, 11 (top segment), and 15.

The Episode View GUI may display a chart visually representing a timeline of the plurality of events in relation to at least one parameter value (see e.g., FIG. 10a1). The timeline may include a plurality of discrete sequential steps, and each step may represent an event associated with a state in the environment. The chart may be a line chart having an x-axis being the timeline and the y-axis being the at least one parameter value (or vice versa). The at least one parameter value may be a numerical measurement of a characteristic of the simulation, such as a parameter which represents at least one effect of a plurality of effects or at least one state of the plurality of states. Non-limiting examples include a critic value, a reward amount, an entropy measurement, or some other specific dimension (observed or latent). A plurality of parameter values may be displayed in the Episode View GUI at once, or the user may select a single parameter value to display and may toggle between different parameter values.

The Episode View GUI may enable a user to zoom into the curve at a particular step or range of consecutive steps to further investigate the RNN model 106. The Episode View GUI may have a replay view (see e.g., FIG. 10a2) to replay the simulation over the selected step(s), such as by showing a video replay clip or a schematic of a series of steps and/or decisions over the selected step(s). The Episode View GUI may also show an action probability distribution showing a probability of the agent taking a specific action at a particular step (see e.g., FIG. 10a2). Users can also select specific steps on the line chart by including a thresholding line which narrows the steps of interest to those having a parameter value above or below a specific threshold.

With continued reference to FIG. 1, from the model data 106, the computing device 110 may generate a second GUI, hereinafter referred to as a “Projection View GUI” or a “Segment View GUI”. Non-limiting examples of Projection View GUIs in the environment described in the Examples are shown in FIGS. 10c, 11 (bottom segment), and 16-18.

The Projection View GUI may be based on multi-dimensional intermediate data between transformations in the RNN model that connect at least one state of the plurality of states to at least one event of the plurality of events, the Projection View GUI comprising a point chart (see e.g., FIG. 10c2) visually representing a two-dimensional projection of the multi-dimensional intermediate data, each point of the point chart representing a time step and at least one event from the time step. More than one point chart may be displayed, e.g., one for each key step in the transformation. The charts may employ t-distributed stochastic neighbor embedding (t-SNE or tSNE) algorithms to project high-dimensional data to a 2D environment for easy visualization by the user. Each point may represent a single time step and may be colored based on the action take in that step. The user may zoom in to different sections of the point chart to better analyze the data, and the Projection View GUI may be used in conjunction with the Episode View GUI to view the various steps and actions together from different views.

The Projection View GUI may include a bar chart (see e.g., FIG. 10c1) to present the distribution of the distances in the 2D projection space between points of consecutive steps. The x-axis of such charts may represent distance values and the y-axis may represent counts (e.g., in the logarithmic scale) (or vice versa). 2D points representing consecutive steps may be connected to form a segment.

The Projection View GUI may be used to merge less important steps so that the user can quickly identify sudden changes in the simulation, which may be starting points of individual segments based on those points having a large distance to the immediately preceding step.

With continued reference to FIG. 1, from the model data 108, the computing device 110 may generate a third GUI, hereinafter referred to as a “Dimension View GUI”. Non-limiting examples of Dimension View GUIs in the environment described in the Examples are shown in FIGS. 10b, 11 (middle segment), and 19-22.

The Dimension View GUI be generated based on at least one hidden state and/or cell state of the RNN model 106. Based on the Dimension View GUI, the system 100 and/or the user may identify a hidden state and/or cell state impacting an event/action taken by the RNN model 106.

Unlike the Episode and Projection View GUIs that present step-oriented visualizations, the Dimension View GUI may present dimension-oriented visualization by focusing on hidden/cell states of the RNN model to enable the system and/or user to identify hidden/cell states which may impact the RNN model 106.

In some non-limiting embodiments or aspects, the Dimension View GUI may comprise at least two rows including a plurality of visual representations on each row, each visual representation of the plurality of visual representations visualizing a hidden state and/or a cell state for one dimension of a plurality of dimensions of the model, wherein a first row of the at least two rows visually represents static global information of the plurality of steps, and wherein a second row of the at least two rows visually represents local information of a single step associated with the first GUI (see e.g., FIG. 10b1). The static global information may include information of all steps, such as mean/variance of a given variable. The local information may be local information for a particular step, such as a step selected from the Episode View GUI. The system 100 and/or user may sort the dimensions based on at least one metric, which the user may select. Sorting the dimensions may enable the system 100 and/or user to quickly understand the dimension(s) most strongly impacting a particular metric.

In some non-limiting embodiments or aspects, the Dimension View GUI may include a visual representation of contrasted distributions over different subsets of steps of the simulation (see e.g., FIGS. 10b2 and b3). For example, the distribution of a plurality of metrics may be compared over the different subset of steps using violin plots (e.g., symmetric histograms) (see e.g., FIG. 10b2), and a pie chart may show the actions selected for the selected steps (see e.g., FIG. 10b2).

As shown in FIGS. 10 and 11, the Episode View GUI, Projection View GUI, and Dimension View GUI may all be displayed within the same primary GUI 1000, 1100. Alternatively, some combination of 2 of these 3 views may be displayed in the same primary GUI, such as the Episode and Dimension View GUIs, the Episode and Projection View GUIs, or the Dimension and Projection View GUIs.

Referring again to FIG. 1, based on the GUIs generated on the computing device 110, the system 100 and/or the user may interact with the model system 104 to evaluate the RNN model 106.

In some non-limiting embodiments or aspects, the system 100 and/or the user may interact with the model system 104 by perturbing the environment (e.g., the modeling environment 109) at a time step(s) based on user interaction with at least one of the GUIs displayed on the computing device 110. Perturbing the environment may enable the user to observe how the RNN model 106 handles the perturbation to better understand and/or to confirm the logic employed by the RNN model 106. For example, based on at least one of the GUIs, the system 100 and/or user may determine at least one predicted rule generated by the RNN model 106, and this predicted rule may include at least one condition and at least one predicted response to the at least one condition (e.g., how the RNN model 106 is hypothesized to react to a particular condition). The system 100 and/or the user may verify that the RNN model 106 implements the at least one predicted rule by perturbing the environment based on the at least one condition and analyzing a response of the RNN model 106 to the perturbation based on the at least one predicted response. The perturbation may be selected and implemented specifically to test the RNN model's 106 response to a predetermined condition and may analyze the response by comparing the predicted response to the actual response of the RNN model 106.

In some non-limiting embodiments or aspects, updated model data may be generated based on the perturbation, and the server computer 102 may communicate the updated model data to the computing device 110 to display at least one updated GUI based on an output resulting from perturbing the environment. The system 100 and/or user may analyze the result of the perturbation based on the at least one updated GUI.

In some non-limiting embodiments or aspects, the system 100 and/or the user may interact with the model system 104 by replaying at least one subset of consecutive steps. The user may interact with at least one of the GUIs (e.g., provide user input thereto) to cause the at least one subset of consecutive steps to be replayed.

Based on the displayed GUIs, the system 100 and/or user may determine at least one predicted rule generated by the RNN model 106, the at least one predicted rule including at least one condition and at least one predicted response to the at least one condition. The system 100 and/or user may verify that the RNN model 106 implements the determined at least one predicted rule by replaying and/or perturbing at least one first time step corresponding to the at least one condition and analyzing a response of the RNN model after the at least one first time step based on the at least one predicted response. The time step to be replayed and/or perturbed may be selected specifically to test the RNN model's 106 response to a predetermined condition and may analyze the response by comparing the predicted response to the response of the RNN model 106.

With continued reference to FIG. 1, the modeling environment 109 with which the model system 104 interacts may comprise a simulated event, and the plurality of events (e.g., actions) may be associated with the simulated event. The simulated event is not particularly limited and may include any type of simulation scenario capable of being modeled by the model system 104. Non-limiting examples of simulated events capable of being modeled by the model system 104 and evaluated will be described hereinafter.

Referring again to FIGS. 2 and 3, the simulated event may be associated with a modeling environment comprising an electronic payment processing network. The electronic payment processing network may include a merchant system, a transaction processing system, and an issuer system which may communicate to process electronic payment transactions initiated by a payment device of a user, the payment transactions between users and merchants.

The simulated event associated with the electronic payment processing network may be used to model fraud determinations, such that the RNN model may be used to predict when a received electronic payment transaction has been fraudulently initiated and/or the likelihood that an electronic payment transaction has been fraudulently initiated. This may enable the electronic payment processing network to identify fraudulent payment transactions.

The simulated event associated with the electronic payment processing network may be used to model predicted charge-back transactions, such that the RNN model may be used to predict which a transactions are likely to have a charge-back (e.g., a return transaction) occur after the initial payment transaction has been processed and/or to identify fraudulent charge-back transactions and/or the likelihood that a charge-back transaction is fraudulent. This may enable the electronic payment processing network to identify fraudulent charge-back transactions.

The simulated event associated with the electronic payment processing network may be used to model cross-border transactions, such that the RNN model may be used to predict which users are likely to engage in cross-border transactions (e.g., a transaction initiated in country other than the user's base country) and/or when and/or where such cross-border transactions are likely to occur. This may enable the electronic payment processing network to communicate relevant communications to potential users expected to engage in cross-border transactions and/or to enable the network to avoid declining cross-border transactions based on the prediction that the user is likely to initiate a cross-border transaction.

It will be appreciated that other implementations of the RNN model with the electronic payment processing network may also be employed.

Referring to FIG. 2, a system 200 is shown for evaluating a RNN model and/or providing dynamic user interfaces for a RNN model in connection with an electronic payment processing network according to some non-limiting embodiments or aspects. The system 200 may include a payment device 202 of a user used to initiate electronic payment transactions. The system 200 may include an electronic payment processing network 214, which may also be the modeling environment 216. The system may include a model system 218.

The electronic payment processing network 214 may include a merchant system 204 of a merchant in communication with a transaction processing system 206 of a transaction service provider. The transaction processing system 206 may be in communication with an issuer system 212 of an issuer. The merchant system 204, the transaction processing system 206, and the issuer system 212 may communicate to process electronic payment transactions initiated by the payment device 202 to completion, such as by authorizing, clearing, and settling the electronic payment transactions.

With continued reference to FIG. 2, in some non-limiting embodiments or aspects, an electronic payment transaction may be initiated by a user (e.g., a consumer) using a payment device 202 accepted by the merchant system 204. The merchant system 204 may generate a transaction request message containing transaction data including data associated with the specific transaction being completed (e.g., goods and services data, price data, and the like), account data associated with the payment device 202 (e.g., PAN number, expiration date, cvv code, and the like), and other data specified in ISO 8583. The merchant system 204 may communicate the transaction request message to a transaction processor 208 of the transaction processing system 206. The transaction processor 208 may generate an authorization request containing at least a portion of the data from the transaction request message. The transaction processor 208 may communicate the authorization request to the issuer system 212 which issued the payment device 202 to the user, to cause the issuer system 212 to generate an authorization decision. The authorization decision may be to authorize the transaction, causing further processing thereof, or to decline the transaction, causing termination of processing using the payment device 202. The issuer system 212 may generate an authorization response containing the authorization decision and communicate the authorization response to the transaction processor 208. The transaction processor 208 may generate a transaction response message containing the authorization decision and communicate the transaction response message to the merchant system 204.

With continued reference to FIG. 2, in some non-limiting embodiments or aspects, the transaction processor 208 may communicate historical transaction data to the historical transaction data database 210 to be stored therein. The historical transaction data may be stored in the historical transaction data database 210 for each transaction handled by the transaction processing system 206. The historical transaction data may include the above-described transaction data, the authorization decision, subsequent clearing and settlement data, subsequent data regarding a report that a transaction was fraudulent and/or any other data relevant to the transactions.

With continued reference to FIG. 2, the system 200 may include the model system 218 having the same characteristics as the model system previously described. The model system 218 may include an RNN model 222 and a model data database 220 for storing model data generated by the RNN model 222. The model system 218 may be in communication with the modeling environment 216 (also the electronic payment processing network 214) to generate model data based on data received from the electronic payment processing network 214. For example, the model system 218 may be in communication with the transaction processing system 206, such as the RNN model 222 being in communication with the historical transaction data database 210. Data from the historical transaction data database 210 may be used as input to the RNN model 222, and the RNN model 222 may generate and store model data in the model data database 220.

The RNN model 222 in communication with the historical transaction data database 210 may simulate an event associated with the electronic payment processing network 214, where the events/actions comprise payment transactions associated with transaction data (e.g., the historical transaction data stored in the historical transaction data database 210). The states in these simulated events may comprise a fraud determination, a predicted charge-back transaction, a predicted future cross-border transaction, and/or other such events associated with the electronic payment processing network 214.

With continued reference to FIG. 2, the RNN model 222 may use any of the historical transaction data relevant for accurately modeling the simulated event. The RNN model 222 may use the historical transaction data as input and may simulate the event associated with the electronic payment processing network 214. The RNN model 222 may generate at least one rule based on its modeling analysis relevant to determining responsive actions suitable for the modeling environment 216. For example, the rule may be associated with identifying a newly received transaction as fraudulent or non-fraudulent, predicting whether a transaction is likely to subsequently be associated with a charge-back transaction and/or whether a charge-back transaction may be fraudulent, and/or whether, when, and/or where a particular user is likely to initiate cross-border transactions in a future time period. The system 200 and/or the user may extract the rules generated by the RNN model 222.

Based on the rules generated by the RNN model 222 interacting with the modeling environment 216 (the electronic payment processing network 214), the system 200 and/or the user may implement the extracted rules in the electronic payment processing network 214, such that future transactions received thereby are evaluated based on the extracted rules, thereby improving the efficiency and/or security of the electronic payment processing network 214. The extracted rules may be applied by the transaction processing system 206, such as the transaction processor 208 thereof. The extracted rules may be stored in a database of the transaction processing system 206. The extracted rules may be applied by the merchant system 204 and/or the issuer system 212.

With continued reference to FIG. 2, a non-limiting example of a simulated event in which the electronic payment processing network 214 is the environment comprises a simulated electronic payment fraud determination event. The historical transaction data from the historical transaction data database 210 may be sent to the RNN model 222 as input, such that the RNN model 222 can analyze the data to generate model data associated with determining whether an electronic payment transaction is fraudulent or non-fraudulent (or the likelihood thereof). The model data may include at least one rule generated by the RNN model 222 associated with determining whether an electronic payment transaction is fraudulent or non-fraudulent. The system 200 and/or the user may extract such rules, and such rules may be applied by the electronic payment processing network 214, such as the transaction processing system 206, to analyze future electronic payment transactions received by the electronic payment processing network 214 to determine whether those transactions are fraudulent and/or non-fraudulent. This may enable the electronic payment processing network 214 to detect and prevent fraudulent transactions before they are processed, resulting in a more secure electronic payment processing network 214.

With continued reference to FIG. 2, the system 200 and/or user may perturb the RNN model 222 by submitting a simulated electronic payment transaction thereto for a simulated fraud determination, in order to test whether the extracted rule accurately reflects the RNN model's 222 behavior when interacting with the modeling environment 216. The characteristics of the simulated electronic payment transaction may be selected to test at least one rule, and the action of the RNN model 222 (e.g., determining that the simulated electronic payment transaction is fraudulent and/or non-fraudulent) may be analyzed to determine the accuracy of the extracted rule by comparing the action taken to the expected action (based on the extracted rule).

Referring to FIG. 3, a system 300 is shown which includes a RNN model system integrated with an electronic payment processing network according to some non-limiting embodiments or aspects. The system 300 includes the same characteristics of the system 200 from FIG. 2, but differs therefrom as follows.

The system 300 may include the payment device 302, electronic payment processing network 303, merchant system 304, transaction processing system 306, transaction processor 308, and issuer system 316 as described in connection with the system of FIG. 2. Moreover, the system 300 may include the model system 310, RNN model 312, and model data database 314 as described in connection with the system of FIG. 2. However, in this non-limiting embodiment or aspect, the model system 310 is integrated into the transaction processing system 306 as a component thereof, such that the model system 310 is a component of the electronic payment processing network 303. The RNN model 312 of the model system 310 may be a trained RNN model trained on historical transaction data of the electronic payment processing network 303, as described in connection with FIG. 2.

With continued reference to FIG. 3, integration of the model system 310 into the transaction processing system 306 may enable the electronic payment processing network 303 to detect and prevent fraudulent transactions before they are fully processed, resulting in a more secure electronic payment processing network 303. The transaction processor 308 may receive a transaction request message from the merchant system 304, the transaction request message associated with a new electronic payment transaction. The transaction request message may be sent to the model system 310 to cause the RNN model 312 to evaluate the new transaction data contained in the transaction request message. Based on the RNN model 312, and the rules learned thereby from training, the RNN model 312 may determine the state of the new transaction, such as that the new transaction is fraudulent or non-fraudulent and/or that the new transaction has a fraud score indicating the likelihood that it is fraudulent (such that it should be denied when the fraud score is above a certain threshold).

In response to the determined state of the new transaction (e.g., a fraudulent state), the transaction processor 308 and/or the issuer system 316 may deny authorization of the new transaction, as a result of the determined state being that the new transaction is fraudulent and/or has a high likelihood of being fraudulent. The transaction processor 308 may communicate the transaction response message containing the authorization denial to the merchant system 304 to terminate the new transaction.

With continued reference to FIG. 3, the model system 310 integrated with the electronic payment processing network 303 may be periodically or continuously trained using newly received transaction data so that the RNN model 312 can further refine its generated rules and/or generate new rules for handling future transactions over the electronic payment processing network 303.

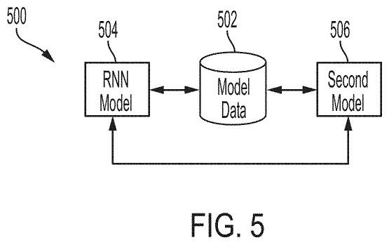

Referring to FIG. 5, in some non-limiting embodiments or aspects, a system 500 and/or the user may interact with the model system by using the RNN model 504 to train a second deep learning model (the second model) 506. The second model 506 may be any type of machine learning algorithm, including a second RNN model. The RNN model 504 may communicate with the second model 506 to train the second model.

With continued reference to FIG. 5, the system 500 may include a model data database 502, and the RNN model 504 and the second model 506 may both store their generated model data in the model data database 502, such that each of the RNN model 504 and the second model 506 may train using the model data generated from the other model.

The RNN model 504 and the second model 506 may both be in communication with the same modeling environment (not shown) such that the inputs to each model are the same and both models generate models using the same inputs. The independently generated RNN model 504 and second model 506 may compete against one another to determine which model more accurately understands the simulation.

With continued reference to FIG. 5, the system 500 and/or user may evaluate each model as previously described to determine the various rules implemented by each model. For rules that are found to be sufficiently effective for one of the models, the system 500 and/or the user may program the other of the models to implement the effective rule to further improve the other of the models.

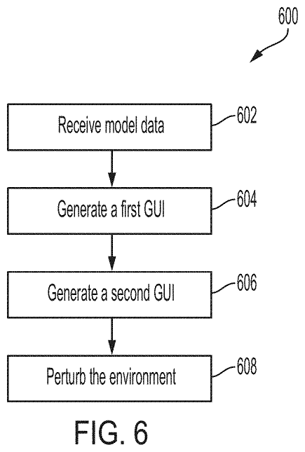

Referring to FIG. 6, a method 600 is shown for evaluating a RNN model according to some non-limiting embodiments or aspects. At a step 602, at least one processor may receive model data generated by a RNN model, the model data comprising a plurality of events associated with a plurality of states in an environment. At a step 604, at least one processor may generate a first graphical user interface (GUI) comprising a chart visually representing a timeline for the plurality of events in relation to at least one parameter value based on the plurality of events and the plurality of states. At a step 606, at least one processor may generate a second GUI comprising a point chart visually representing a two-dimensional projection of the multi-dimensional intermediate data, each point of the point chart representing a time step and at least one event from the time step, based on multi-dimensional intermediate data between transformations in the RNN-based deep learning model that connect at least one state of the plurality of states to at least one event of the plurality of events. At a step 608, at least one processor may perturb the environment at a time step based on user interaction with at least one of the first GUI and the second GUI.

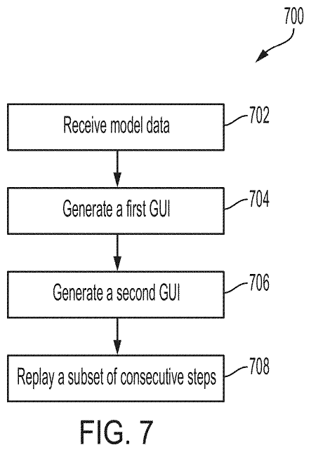

Referring to FIG. 7, a method 700 is shown for evaluating a RNN model according to some non-limiting embodiments or aspects. At a step 702, at least one processor may receive model data generated by a RNN-based deep learning model, the model data comprising a plurality of events associated with a plurality of states in an environment. At a step 704, at least one processor may generate a first graphical user interface (GUI) comprising a chart visually representing a timeline for the plurality of events in relation to at least one parameter value based on the plurality of events and the plurality of states. At a step 706, at least one processor may generate a second GUI comprising a point chart visually representing a two-dimensional projection of the multi-dimensional intermediate data, each point of the point chart representing a time step and at least one event from the time step, based on multi-dimensional intermediate data between transformations in the RNN-based deep learning model. At a step 708, at least one processor may replay at least one subset of consecutive time steps based on user input received through at least one of the first GUI and the second GUI.

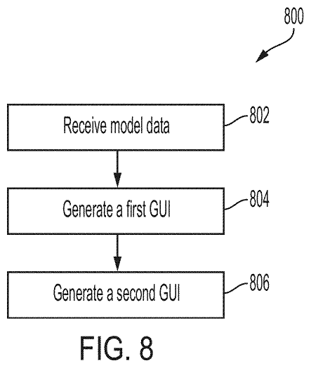

Referring to FIG. 8, a method 800 is shown for evaluating a RNN model according to some non-limiting embodiments or aspects. At a step 802, at least one processor may receive model data generated by a RNN-based deep learning model, the model data comprising a plurality of events associated with a plurality of states in an environment. At a step 804, at least one processor may generate a first graphical user interface (GUI) comprising a chart visually representing a timeline for the plurality of events in relation to at least one parameter value based on the plurality of events and the plurality of states. At a step 806, at least one processor may generate a second GUI comprising a first plurality of visual representations and a second plurality of visual representations, each visual representation representing a hidden state and/or a cell state for one dimension of a plurality of dimensions of the model, based on at least one hidden state and/or cell state of the RNN-based deep learning model, wherein the first plurality of visual representations is based on static global information of the plurality of steps, and wherein the second plurality of visual representations is based on local information of a single step associated with the first GUI.

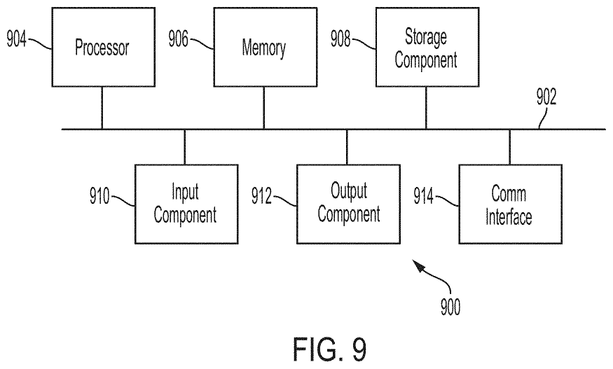

Referring now to FIG. 9, shown is a diagram of example components of a device 900 according to some non-limiting embodiments or aspects. Device 900 may correspond to any of the components or devices shown in FIGS. 1-3. In some non-limiting embodiments or aspects, such systems or devices may include at least one device 900 and/or at least one component of device 900. The number and arrangement of components shown in FIG. 9 are provided as an example. In some non-limiting embodiments or aspects, device 900 may include additional components, fewer components, different components, or differently arranged components than those shown in FIG. 9. Additionally, or alternatively, a set of components (e.g., one or more components) of device 900 may perform one or more functions described as being performed by another set of components of device 900.

As shown in FIG. 9, device 900 may include a bus 902, a processor 904, memory 906, a storage component 908, an input component 910, an output component 912, and a communication interface 914. Bus 902 may include a component that permits communication among the components of device 900. In some non-limiting embodiments or aspects, processor 904 may be implemented in hardware, firmware, or a combination of hardware and software. For example, processor 904 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 906 may include random access memory (RAM), read only memory (ROM), and/or another type of dynamic or static storage device (e.g., flash memory, magnetic memory, optical memory, etc.) that stores information and/or instructions for use by processor 904.

With continued reference to FIG. 9, storage component 908 may store information and/or software related to the operation and use of device 900. For example, storage component 908 may include a hard disk (e.g., a magnetic disk, an optical disk, a magneto-optic disk, a solid state disk, etc.) and/or another type of computer-readable medium. Input component 910 may include a component that permits device 900 to receive information, such as via user input (e.g., a touch screen display, a keyboard, a keypad, a mouse, a button, a switch, a microphone, etc.). Additionally, or alternatively, input component 910 may include a sensor for sensing information (e.g., a global positioning system (GPS) component, an accelerometer, a gyroscope, an actuator, etc.). Output component 912 may include a component that provides output information from device 900 (e.g., a display, a speaker, one or more light-emitting diodes (LEDs), etc.). Communication interface 914 may include a transceiver-like component (e.g., a transceiver, a separate receiver and transmitter, etc.) that enables device 900 to communicate with other devices, such as via a wired connection, a wireless connection, or a combination of wired and wireless connections. Communication interface 914 may permit device 900 to receive information from another device and/or provide information to another device. For example, communication interface 914 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 900 may perform one or more processes described herein. Device 900 may perform these processes based on processor 904 executing software instructions stored by a computer-readable medium, such as memory 906 and/or storage component 908. A computer-readable medium may include any non-transitory memory device. A memory device includes memory space located inside of a single physical storage device or memory space spread across multiple physical storage devices. Software instructions may be read into memory 906 and/or storage component 908 from another computer-readable medium or from another device via communication interface 914. When executed, software instructions stored in memory 906 and/or storage component 908 may cause processor 904 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

### EXAMPLES

The following example is provided as a proof of concept as to how a recurrent neural network (RNN)-based deep learning model can be evaluated according to some non-limiting embodiments or aspects. In this example, the RNN-based deep learning model is evaluated in the context of interacting in a videogame environment, but it will be appreciated that this is just one non-limiting examples of evaluating RNN-based deep learning models in an environment. Other environments are contemplated and are within the scope of this disclosure, such as the environments previously described.

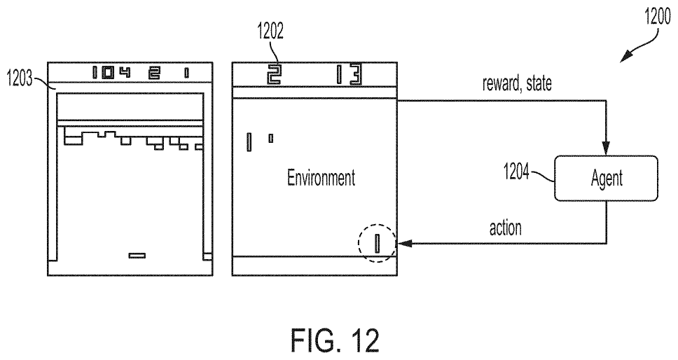

Reinforcement learning (RL) strives to train a software agent that can issue proper actions to interact with an environment and maximize the accumulated reward. With the successful applications of deep neural networks (DNNs), deep reinforcement learning (DRL) has achieved a few breakthroughs recently in playing Go and different Atari Games. Each game is an environment with varying states at different game stages. The agent consumes the states, analyzes and responds them by issuing actions following certain strategies. In response, the environment provides rewards, along with the next state, as feedback to the agent to optimize its strategies. An exemplary RL interaction loop with Atari games (e.g., Breakout, Pong) is shown in FIG. 12. FIG. 12 shows a system 1200 in which an agent 1204 interacts with a game environment 1202 (Pong), 1203 (Breakout) using RNN-based deep learning model according to some non-limiting embodiments or aspects.

Two major approaches in implementing DRL are convolutional neural network (CNN) based and RNN-based, and their difference is in the way of encoding the dynamic information in the game states. For example, the state of the Pong game should reflect not only the position (static information), but also the speed and direction of the ball (dynamic information). CNN-based approaches capture dynamic information by combining a sequence of consecutive game screens as a state. In contrast, RNN-based approaches encode this through RNNs' internal hidden states. RNN-based approaches were the focus of these examples for three major reasons. First, RNN-based implementations usually involve a CNN component to pre-process individual game frames and thus are more complicated. Second, little discovery on RNN models for DRL has been reported thus far. Third, compared to other time-series data, the game state sequences from DRL are more interesting, more complicated, and more challenging to analyze.

Apart from the super-human performance of RNN-based DRL models trained to play different games, exploring, understanding, and diagnosing them remains challenging. There are very few tools that DRL researchers can use to efficiently overview a long game episode. Often, their evaluation of a trained DRL agent is limited to numerical summary statistics (e.g., average rewards per episode), and many details regarding the learned playing strategies of the agent are waiting to be revealed. Second, identifying the interpretable cells of the RNN models and interpreting what they have captured in the context of different games is very challenging, due to the complicated and high-dimensional (HD) data representation inside RNN. Third, the capability of enabling DRL experts to flexibly interact with a DRL model is still missing. Given that the experts often need to verify their hypothesis on different functionalities of the model, this capability is desired.

Targeting the aforementioned challenges, DRLxplore, a visual analytics system to explore, interpret, and diagnose the RNN-based DRL models, has been developed. The focus application was on Atari 2600 games, as they are well-known by the public. Three practical analytical tasks were targeted: (1) enable thorough explorations of a game episode; (2) identify critical hidden/cell states from RNN-based DRL models and interpret what they have captured; and (3) empower domain experts to interactively perform the “what-if” (perturb) hypothesis verification. This work was conducted in close collaboration with multiple DRL experts and verifies the effectiveness of DRLxplore with them through concrete case studies, which are then applicable to other use cases. In summary, the contributions of this work include: (1) design and development of DRLxplore, a visual analytics system to explore, interpret, and diagnose RNN-based DRL models; and (2) through DRLxplore, discover interpretable cells from RNN-based DRL models, e.g., dimensions of hidden states recording the direction of moving balls, dimensions of cell states counting game steps. These findings with solid visual evidence and interactive verification play important roles in model understanding.

The interaction between a RL agent and an environment generates a sequence of states, actions, and rewards (denoted as sᵢ, aᵢ, and rᵢ, i ∈ [0, T]), and the goal is to maximize the cumulated reward from any time t (Σ^{T}ᵢ₌ₜ rᵢ). In general, there are three RL approaches to achieve this goal: policy-based, value-based, and actor-critic approach. The policy-based approach trains the RL agent by optimizing the conditional probability distribution of the actions (conditioned on previous states) to derive the optimal policy. The value-based approach shares the same goal of deriving the optimal action policy, but it achieves this by optimizing an associated value function. The actor-critic approach combines the merits of both. It contains an actor, which takes advantages of the policy-based approach to optimize the action policy. Meanwhile, it also uses the value-based approach to optimize a critic, which tells how good the current policy is. This work focused on the actor-critic approach, so that it can be easily generalized to value-based and/or policy-based approaches.

The state-of-the-art implementation of the actor-critic approach is the advantage actor-critic (A2C), whose loss is defined as follows:

[symbol]

= [symbol] ᵥₐₗᵤₑ+ [symbol] _{policy} (1)

[symbol]

ᵥₐₗᵤₑ=Σᵢ₌ₜ^{T}(Rᵢ−V(sᵢ))², Rᵢ=rᵢ+γV(sᵢ₊₁) (2)

[symbol]

_{policy}=−Σᵢ₌ₜ^{T} log(π(aᵢ|sᵢ))Aᵢ−H(π(aᵢ|sᵢ)) (3)

Aᵢ=Σₗ₌₀^{k-1}(γλ)^{l}δᵢ₊ₗ, δᵢ=Rᵢ−V(sᵢ)=rᵢ+γV(sᵢ₊₁)−V(sᵢ) (4)

The value loss minimize the error between the value function (V(sᵢ)) and the discounted future reward Rᵢ (with a discount factor γ), i.e., the Temporal-Difference (TD) error. The policy loss contains two parts. π(aᵢ|sᵢ) from the first part is the probability of generating aᵢ when seeing sᵢ. A(sᵢ,aᵢ) is the advantage function (a scoring function) evaluating how good aᵢ is when seeing sᵢ. The second part encourages a larger entropy in the action distribution, such that the agent becomes less decisive in issuing actions and more willing to explore different actions. More details behind these equations can be found in Equations (1-4).

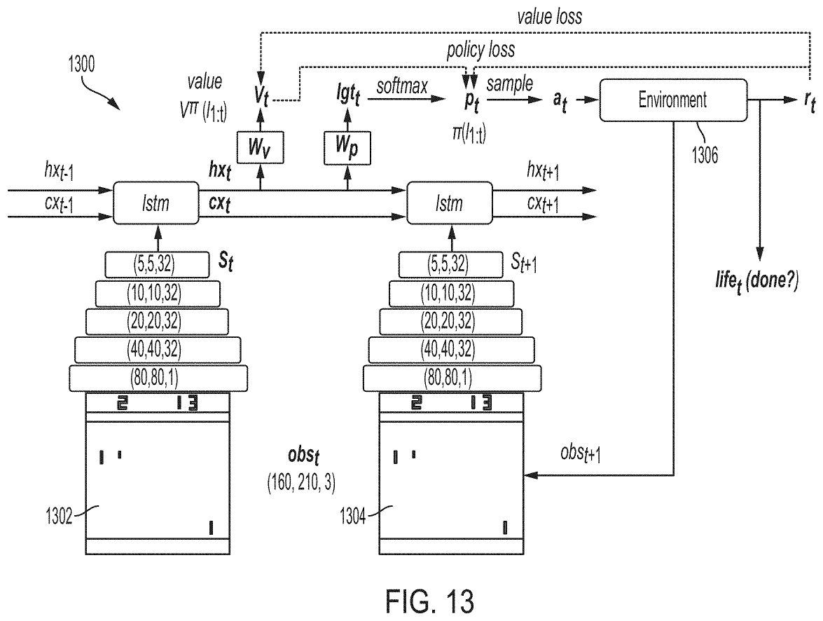

V(s) and π(a|s) (value and policy function) in the above equations are parameterized by a RNN-based DRL model. The model uses a RNN on top of the CNN activations extracted from individual game screens to capture the temporal evolution of the environment. FIG. 13 shows the used architecture of the RNN-based DRL model. FIG. 13 shows a system diagram of an architecture 1300 and data flow for a RNN-based deep learning model according to some non-limiting embodiments or aspects.

For a given game screen 1302 (obsₜ, with size 160×210×3) from the environment 1306, the model first shrinks it and converts it to gray-scale (80×80×1), and then applies a CNN on top of it to extract the essential state information. In this particular case, a CNN with four convolutional layers is used, each halves the size of the input, and the size of the last layer activation is 5×5×32 (sₜ), which is the input of the RNN cells.

Two major architectures of RNN are Long Short-Term Memory (LSTM) and Gated Recurrent Unit (GRU). LSTM has both hidden states and cell states, whereas GRU contains only hidden states. Both architectures have been used in this work, and the LSTM/GRU cells are considered black-boxes, which combine the current state (sₜ), the previous hidden (hxₜ₋₁), and cell state (cxₜ₋₁ for LSTM) to produce a new hidden (hxₜ) and cell state (cxₜ), as shown in Equation 5.

hxₜ, cxₜ=LSTM(sₜ, hxₜ₋₁, cxₜ₋₁); hxₜ=GRU(sₜ, hxₜ₋₁) (5)

hxₜ (from LSTM/GRU) is then used to generate the current value of V(s) and π(a|s), i.e., vₜ and pₜ, using two separate fully-connected layers whose weights are wᵥ and wₚ respectively (wᵥ is 1D weight vector, wₚ has the same number of components with the number of possible actions, each is denoted as wⁱₚ). Sampling from the policy will generate the action for the current step, i.e., aₜ˜pₜ, which will be sent to the environment 1306 to generate the reward (rₜ) and next game screen 1304 (obsₜ₊₁). rₜ provides feedback to vₜ to update the network parameters (value loss). rₜ and vₜ together guide the change of pₜ (policy loss). With hxₜ, cxₜ, and obsₜ₊₁, the above process will be repeated until the game ends (e.g., the agent lost all lives).

This work focuses on well-trained agents to reveal what they have learned (instead of the training process). The focus is on three main design themes of episode exploration, hidden/cell state investigation, and interactive perturbation, which have been converted into the following three concrete design requirements to explore, understand, and diagnose DRL models.

### R1: Efficient Episode Overview and Exploration

Apart from conventional summary statistics, domain experts often need to replay a game episode (from game-start to game-end) to watch how a trained agent plays the game and check if any playing strategies have been adopted. Therefore, an efficient game episode overview is the starting point for in-depth investigations. In detail, the system is able to: (1) illustrate the evolution of user-interested summary statistics, e.g., predicted value, action policy; (2) identify important steps over the episode and replay the game from any steps of interest on-demand; (3) reveal possible playing strategies (recurring pattern) that have been adopted by a well-trained agent.

### R2: In-Depth Hidden/Cell State Investigation

It is the domain experts' interest to prove with visual evidence whether interpretable cells can be found in RNN-based DRL. The system is able to: (1) efficiently identify important hidden/cell state dimensions, and the dimensions critical to certain steps of interest; (2) answer how an RL agent notices the environmental state change (e.g., the direction of the ball in Pong) and what the agent really memorized over time; (3) identify dimensions with dissimilar behaviors in different subsets of steps (e.g., the dimensions behave differently in steps with low or high rewards).

R3: Flexibly Interact with the Model and Perturb Model Inputs

With the identified important steps/dimensions, domain experts often ask “what-if’ questions to model's behaviors (e.g., what if the value of dimension i at step j is not that high?). Therefore, the system is able to: (1) perturb the game screen at different steps to see what pixels/regions are more sensitive to the current predictions; and (2) manipulate the hidden/cell states to verify if the previously identified hidden/cell state dimensions really play the expected role.

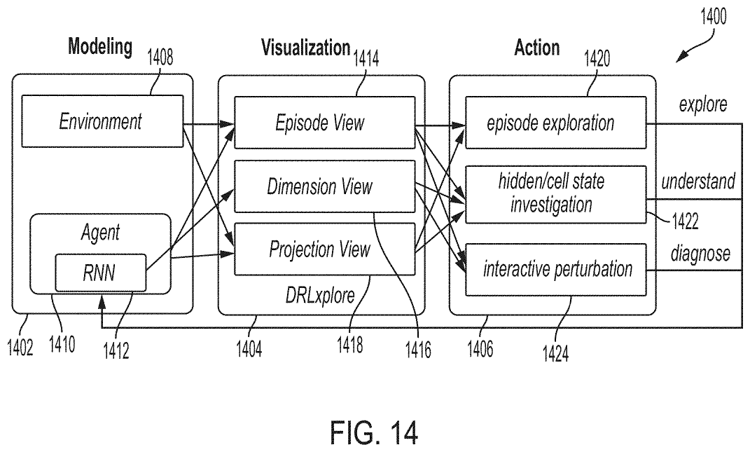

FIG. 14 shows a system 1400 for evaluating a RNN-based deep learning model according to some non-limiting embodiments or aspects and provides an overview of DRLxplore (FIG. 10) which connects DRL models and humans on the two sides and provides a manner for humans to explore, understand, and diagnose the complicated DRL models. The system 1400 includes a modeling component 1402, which includes the environment 1408 and the agent 1410 working from the RNN model 1412.

Aligned with the design requirements, DRLxplore is implemented with three coordinated visualization components 1404, which enable certain action components 1406. The Episode view 1414 (see FIG. 10(a)) adopts the overview and an episode exploration mechanism 1420 to provide a compact overview of a game episode through superimposed line charts and on-demand details through animation replay. DRL agents predict actions through a complicated data transformation process. The Projection view 1418 (see FIG. 10(c)) employs five synchronized views to present the data in five stages of this transformation. Each view is a tSNE projection of the data from all time steps and these steps can be connected in a temporal order based on their similarity. The Dimension view 1416 (see FIG. 10(b)) enables the easy selection and exploration of important hidden/cell state dimensions 1422 related to all game steps, a subset of steps, or a single step. Coordinated with the Episode view 1414, users can effectively select dimensions in this view and interpret them in the Episode view 1414. With hypotheses formed over the exploration and understanding of the DRL model, these views also work together to support users to interactively perturb 1424 the network and verify their hypothesis.

DRLxplore was developed with three main visualization views, described in detail below.

### Episode View

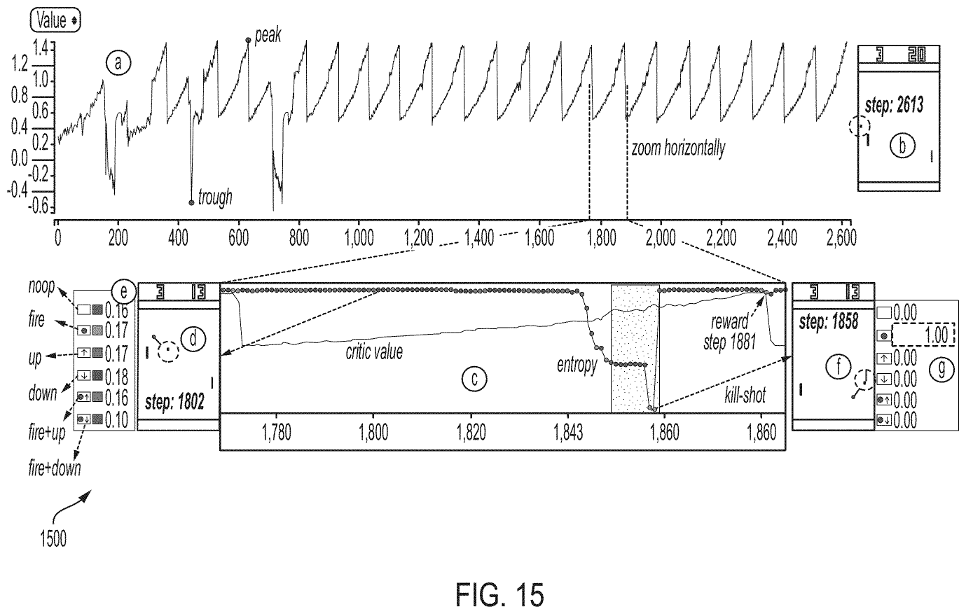

The Episode view is the interface for users to quickly overview an entire game episode (from game-start to game-end) and provide informative guidance for them to dive into specific game steps for detailed investigation (R1). The overview is accomplished through superimposed line charts, in which users can flexibly select one or multiple numerical measurements (e.g., the critic values, the rewards, or a specific dimension of the hidden states) over the entire episode (see FIG. 10(a1)). To reflect how the action probability distribution (i.e., policy π(a|s)) evolves over time, entropy of the distribution is presented at individual steps (the curve in FIG. 10(a1)). The lower the entropy, the more confident the agent is in issuing the action. Based on the presented overview, users can zoom the curves into a particular time range and select the range to replay the game and perform investigations with the Game-Replay view (see FIG. 10(a2)). FIG. 15 shows a graphical user interface 1500 associated with episode view according to some non-limiting embodiments or aspects. As shown in FIG. 15(c), when the zoomed region contains less than 300 steps, circles with different colors (indicating the step taken in different steps) may be visible and users can click individual ones to specify the starting step for investigation. The widget in FIG. 10(a4) controls the length of the game to be replayed.

The Game-Replay view (see FIG. 10(a2)) presents the selected game steps as a video clip and the action probability distribution as a vertical bar chart. Different glyphs (see FIG. 15(e)) are designed to present the possible actions.

Users can also select steps from the curve on the left of the Episode view through a thresholding line (the horizontal line shown in FIG. 10(a1). Currently, the line is pointing down, so steps on the curve with values less than the horizontal line will be selected and the corresponding steps are highlighted in the Projection view (see FIG. 10(c2), introduced later).

### Projection/Segment View

The Projection view (see FIG. 10(c)) demonstrates the intermediate data representations from five key steps of the transformation (conducted through DNNs) from a sequence of game states to actions. They are the input game screens, the last layer's actions from the CNN, the hidden states, the cell states (if LSTM is used), and the logits for different actions, which are denoted as obsₜ, sₜ , hxₜ, cxₜ , and lgtₜ (t ∈ [0,T]) in FIG. 13 respectively. Each of the five juxtaposed views in FIG. 10(c) contains a tSNE projection view (a scatterplot) and a histogram bar chart.

The tSNE view (see FIG. 10(c2)) employs the tSNE algorithm to project the high-dimensional data to 2D for visualization. Each point represents one time step and is colored based on the action taken in that step. Consistent color mapping may be used in the Projection view and the Episode view (FIGS. 15(c, e)). The interface on the top-left corner allows users to switch between zoom and selection modes. Semantic zoom is enabled to make this view scale better to episodes with a large number of steps. Lasso selections facilitate users to flexibly select the steps of interest.

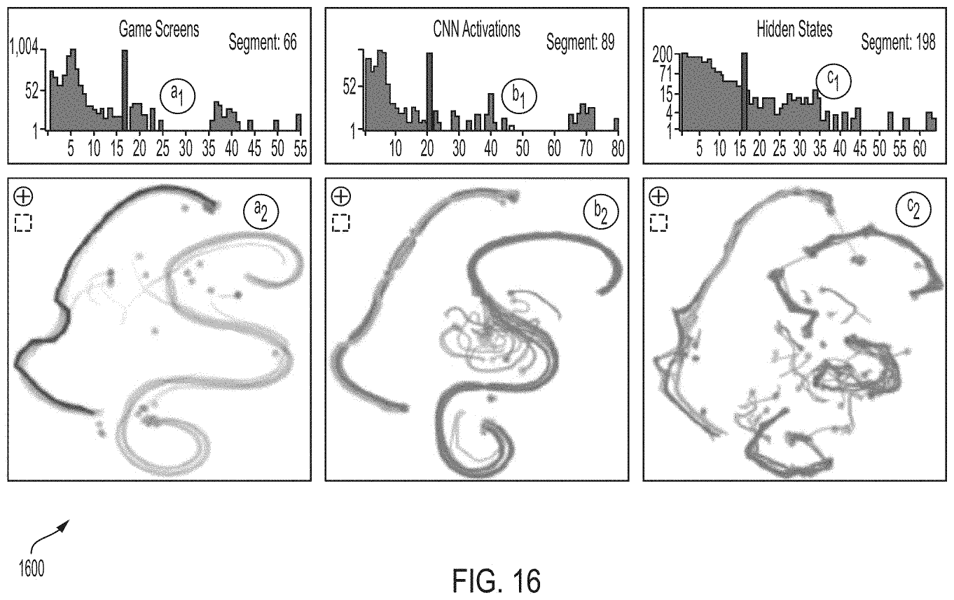

The bar-chart (see FIG. 10(c1)) presents the distribution of the distances (in the 2D projection space) between points of consecutive steps. The horizontal axis represents the distance values and the vertical axis represents counts in the logarithmic scale. The 2D points representing consecutive steps in the tSNE can be connected to form a segment (e.g., connecting the consecutive input screens will form an animation). The red vertical line in the bar-chart view specifies a threshold. Consecutive 2D points with distance less than it will be connected in the tSNE view. For example, the threshold is 16 in FIG. 16(a1), and points that have a distance to its ancestor less than 16 are connected to form a segment in FIG. 16(a2). FIG. 16 shows a graphical user interface 1600 associated with projection view according to some non-limiting embodiments or aspects. The purpose of this visualization is to merge less important steps and help users quickly identify sudden changes in the game episode, which are the starting points of individual segments, as those points have a large distance to their previous steps. Taking the Pong game as an example, two consecutive steps, in which the ball moves in opposite directions, may have very different hidden states and their resulting tSNE projections will also be far from each other. Highlighting them will help users identify the steps where the ball bounced with the paddle.

Three optimizations in the tSNE projection views were developed. First, an overlap window for the projection of obsₜ and sₜ was developed. In FIG. 10(c2), each point represents a sequence of n consecutive game screens, i.e., [obsₜ₋ₙ: obsₜ]. n=20 was used in this case but it can be adjusted on-demand. Based on the observations, this optimization works well to stabilize the projections of obsₜ and sₜ. It is not applied to hxₜ, cxₜ, or lgtₜ, as they should already capture the temporal information through the RNN model. Also, to reduce the time cost of tSNE projection for obsₜ and sₜ (as they have much higher dimensionality than hxₜ, cxₜ and lgtₜ), principle component analysis was applied on them first to reduce their dimensionality to 256 before the tSNE operation. Second, the tSNE projection result of obsₜ is used as the initialization for the tSNE projection of the following four views. Without a common initialization, the global layout of individual steps in the five tSNE views will be very inconsistent. After applying this optimization, the layout was found of obsₜ, sₜ, and hxₜ of the Pong game (FIG. 10(c)) and shows much more consistent layouts, which eases the understanding of these views. For example, the orange points in the red dashed rectangles in FIG. 10(c) represent the same steps in five different stages, and they always appear in the bottom-left corner in all five views. Third, synchronized interaction among the five tSNE projections is empowered. When users highlight/select any point/segment in one view (FIG. 16(a2)), the other four views (FIGS. 16(b2, c2)) will synchronize the selection. The selected segment in FIG. 16(a2) is in three segments in FIG. 16(c2) connected with thinner orange lines.

### Dimension View

Different from the Episode and Projection view that present step-oriented visualizations, the Dimension view presents dimension-oriented visualization by focusing specifically on the hidden/cell states of the RNN model. The goal of this view is to provide users with effective ways to identify interesting hidden/cell states, which can be accomplished by (1) interleaved dimension-step interactions and (2) comparing contrasted distributions over different subsets of steps.

The interleaved dimension-step interaction is conducted through two rows of rectangles connected with Bezier Curves. Each row contains 256 rectangles representing the 256 hidden/cell state dimensions of the RNN model. The top row presents the static global information of all steps (such as the mean/variance of hₓ wᵥ, each component of wₚ), whereas the bottom row presents the local information of a single step (selected from the Episode view). For example, the color of each top row rectangle in FIG. 10(b1) presents the second component of the policy weight w¹ₚ. It is a global metric as all steps share the same values. By interacting with the gray rectangles on the very left of FIG. 10(b1), users can switch to other metrics, e.g., the mean or variance of hₓ, the value weight wᵥ, or other components of wₚ (wⁱₚ). The color of each rectangle in the bottom row presents hx, hx·wᵥ, or hx·wⁱₚ of individual dimensions for the currently selected step. Currently, it shows the multiplication between the hidden state in step 1960 and the second component of wₚ i.e., hx₁₉₆₀·w¹ₚ. The multiplication shows the decomposition of final policy logit for the fire action across all internal RNN dimensions, which reveals the importance of individual dimensions to the fire action. Users can sort the 256 dimensions based on the currently visualized metric. The links between the two rows of rectangles show the relation between the global and local metric and the order difference. Clicking individual rectangles will visualize the hidden state value of that dimension across all steps, i.e., [hx₀[d], hx₁[d], . . . , hx_{T-1}[d]], in the Episode view. The rectangles can also be zoomed in horizontally (see the bottom row of rectangles in FIG. 10(b1)), which alleviates the scalability issues when facing a large number of dimensions.

The second way of dimension selection, i.e., comparing contrasted distributions over subsets of steps, is conducted through the components in FIGS. 10(b2 and b3). FIG. 10(b2) presents the distribution of three metrics through three juxtaposed violin plots (e.g., symmetric histograms). The three metrics presented are the entropy of action probabilities, critical values, and rewards. Users can brush on the top/bottom half of this view to select steps with metric values falling into a desired range. For example, in FIG. 10(b2), two subsets of steps with very low (gray brush) and high (red brush) entropies are selected. The pie chart on the right shows the distributions of actions in the selected steps (e.g., distribution of the actions conditioned on the brushed steps).

After the selection of the two subsets of steps, DRLxplore will construct two distributions (over the hidden state values) for the two subsets and compute the Jensen-Shannon divergence (JSD) between the two distributions for individual dimensions. In detail, for a specific dimension d of the hidden states, assume the two subsets of selected steps are P and Q, the divergence value of dimension d is computed as follow (Dist( ) is the operation of constructing a distribution from a 1D array):

JSD_{d}=JSD(Dist(hxᵢ[d], ∀i ∈ P)∥Dist(hxⱼ[d], ∀j ∈ Q), d ∈ [0,255]

This computation is conducted across all 256 dimensions of the hidden states, and the result can be seen from the bottom row of rectangles in FIG. 10(b1). Users can sort the dimensions based on the JSD values. After the sorting, they can brush the bars representing dimensions with the largest JSD value. The brushed dimensions and the corresponding distributions will be shown in FIG. 10(b3) as two superimposed histograms. The histograms in gray and red corresponds to the distributions formed by the steps selected in the gray and red brush in FIG. 10(b2). Similar interactions can also be performed with other metrics, e.g., selecting two subsets of steps based critic values.

Three deep learning experts were consulted to investigate the power of DRLxplore. Two Atari 2600 games were the focus of the studies (i.e., Pong, Breakout). However, no game-specific attributes were used in the design, such that DRLxplore can be easily adapted to other Atari games and beyond game environments to real world simulations (e.g., electronic payment processing networks). The focus on Pong was to demonstrate how DRLxplore satisfies the design requirements, and show insightful findings from other games.

Atari Pong (FIG. 12, 1202) simulates the Ping-Pong game between two players. One player (the computer) controls the paddle on the left; the other (the trained DRL agent or human players) controls the paddle on the right. The player loses one point when he fails to catch the ball and gets one point when he makes the opposite fail to catch the ball. The game ends when one player gets 21 points and that player is the winner.

In Breakout (FIG, 12, 1203), the DRL agent controls the paddle on the bottom to catch the ball and use it to destroy the bricks on top of the scene. There are six rows of bricks, each row has 18. Destroying bricks in the top/middle/bottom two rows will get 7/4/1 point respectively, i.e., 432 (2×(7+4+1)×18) points in total. The agent has five lives in total and it loses lives when failing to catch the ball. The game continues until the agent has lost all lives.

The architecture 1300 of the DRL model is shown in FIG. 13. The only difference between models of different games is the number of components in Wₚ (which is dependent on the number of possible actions in each game). State-of-the-art training mechanisms were adopted, e.g., Asynchronous Advantage Actor Critic (A3C), to train the model, i.e., multiple threads of agents (20 in this case) interact with multiple copies of the same environment and asynchronously update the shared model parameters. For each thread, model parameters are updated every 20 steps (the number of recurrent step for RNN is 20), and the total number of parameter updates from all threads is 40 million. Well-trained models were focused on to examine what they have learned and interpret their internal working mechanism.

From the Episode view (FIG. 15(a)). periodical patterns of the critic values can easily be observed. 21 peaks and 3 troughs were observed, corresponding to the steps where the DRL agent obtains or loses points. Checking the game screen of the last step (FIG. 15(b)), the game reward on top of the screen is 3:20 and the computer already fails to catch the ball (the reward will become 3:21 after the ball goes out of the left boundary). This verifies the conclusion about the value curve. One can also flexibly zoom into different peaks or troughs to replay the game and further investigate the video clips for reward gain/loss.

Zooming into a periodical cycle (step 1770-1885, FIG. 15(c)), the value curve (in gray) can be seen, reflecting the expected reward, keeps increasing and a sudden drop appears after the agent gets a reward at step 1881. The entropy curve always keeps high except step 1844-1858. This range is when the ball flies towards the right paddle and the agent needs to carefully adjust his position to bounce the ball back with a good angle and speed. In other words. the agent learns that he only needs to carefully choose actions in the above steps to get rewards. Actions for other steps (e.g., where the ball is too far away or flies away from the right paddle) do not matter. For example, at step 1802 (FIG. 15(d)), the ball is flying towards top-left and the probabilities of taking different actions are almost the same for the agent (FIG. 15(e)).

The most important 10 steps (1849-1858) are highlighted in FIG. 15(c). The well-trained agent is confident in taking the noop actions (in blue) and very confident in taking the fire action (in orange). The 100% confidence step happens exactly when the ball hits the paddle (FIG. 15(f-g)), reflecting the agent's intelligence in controlling the ball.

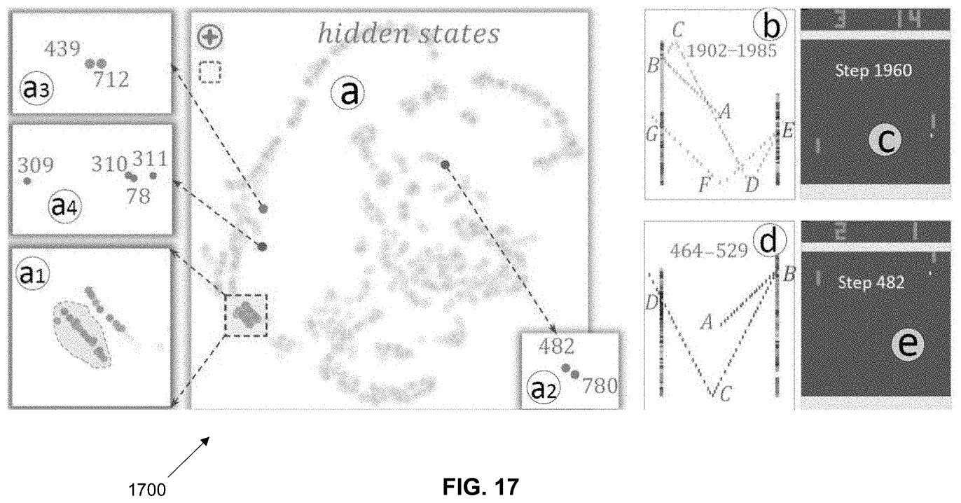

Apart from the above ad-hoc analysis of individual game segments, the experts also want to have an overview of all playing strategies the agent has used. This analysis can be started by focusing on steps with low action probability entropies, i.e., the steps that the agent confidently controlled. These steps can be filtered out by interacting with the thresholding line in the Episode view, as shown in FIG. 10(a1). Steps with entropy less than the red thresholding line are highlighted in the five tSNE views in FIG. 10(c). FIG. 17 shows a graphical user interface 1700 associated with projection view illustrating four different playing strategies according to some non-limiting embodiments or aspects. FIG. 17(a) shows an enlarged version of the tSNE for the hidden states with four clusters. The cluster in FIG. 17(a1) is the biggest and is of the most interest. Hovering over any orange point in this cluster allows users to see the corresponding game screen in the Game-Replay view. For example, the screen for a randomly selected point (step 1960) is shown in FIG. 17(c). Playing with the Episode view, a sequence of steps can be selected before and after this step to show the game context. DRLxplore can compute the variance at per pixel location for the screens for this sequence of steps (1902-1985) and visualize it as a gray-scale image, as shown in FIG. 17(b). The variance map shows the trajectory of the ball, i.e., A-B-C-D-E-F-G. Step 1960 happens at point E, where the agent issues a kill-shot (fire) to kick the ball towards F and eventually makes the opposite fail to catch it at point G. Points were randomly picked from this cluster, and all present the same playing strategy. The Projection view saves users from further analyzing all points individually.

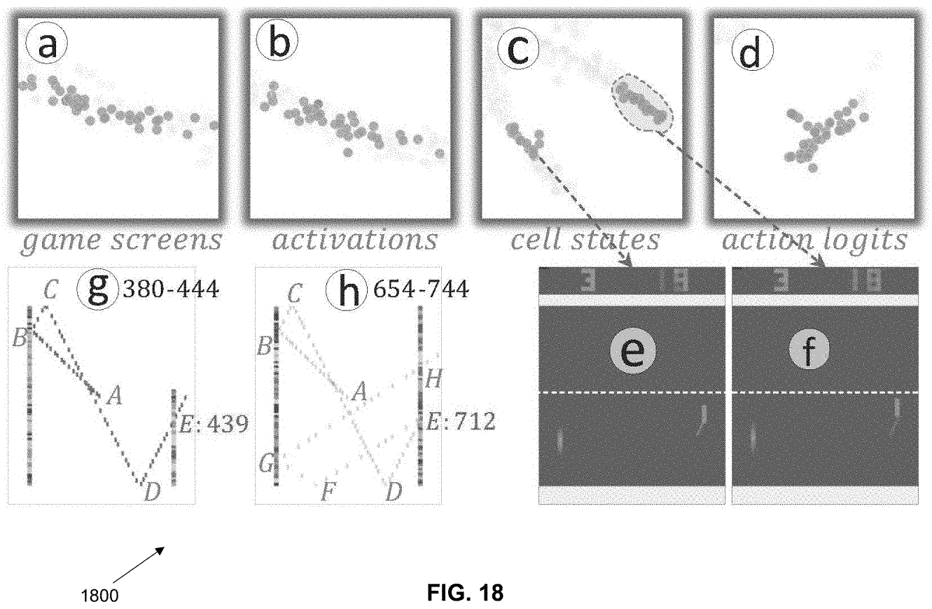

The experts also noticed there are two sub-clusters in the cluster of FIG. 17(a1), and wanted to know the subtle difference between them. FIG. 18 shows a graphical user interface 1800 for further analyzing at least one of the playing strategies illustrated in FIG. 17 according to some non-limiting embodiments or aspects. The zoomed-in views for this cluster in other four tSNE projections are shown in FIG. 18(a-d). It can be seen that the steps only diverge in the hidden state projections (FIG. 17(a1)) and cell state projections (FIG. 18(c)), indicating the game screens, extracted activations, and action logits are very similar, but the agent may adopt different internal mechanisms to process them. By dragging the thresholding line in the histogram view (FIG. 10(c3)), it was found there is no segment connecting steps across the two sub-clusters. Through lasso selections, it was found that the bottom cluster in the hidden-state projections (the shaded cluster in FIG. 17(a1)) corresponds to the top cluster in the cell-state projections (the shaded cluster in FIG. 18(c)). DRLxplore computes the average screen for the two sub-clusters of steps and the results are shown in FIG. 18(e-f). In FIG. 18(e), the left paddle and ball are blurry, indicating their positions have a little variance in this sub-cluster of steps. However, the right paddle position in all these steps is the same. Similar observation can also be found in FIG. 18(f). The major difference between the two aggregated screens is the position of the right paddle. A white dashed line is added to show this subtle difference. This shows minor difference between two playing strategies in bouncing the ball, i.e., one is to use the front face of the paddle to bounce the ball at a relatively lower position (FIG. 18(e)), the other is to use the bottom face of the paddle to bounce the ball at a relatively higher position (FIG. 18(f)). This marginal difference is hardly visible if only investigating the game screens or CNN activations.

FIG. 17(a2) shows another playing strategy. For each round of the game, the ball appears in the middle of the scene but flies towards a random direction. FIG. 17(a1) shows the case that the ball flies toward the left paddle (FIG. 17(b)). FIG. 17(a2) shows the agent's playing strategy when the ball flies toward the right paddle. Zooming into the projection view, it can be seen that there are two blue points in this cluster. One representing step 482 was randomly picked. The game screen for this step and the aggregated variance map for a sequence of context screens are shown in FIG. 17(d-e). In FIG. 17(d), the ball follows the trajectory A-B-C-D, and point B is step 482. At this step, the agent issues the noop action (reflected by the blue color) to wait the ball coming toward the right paddle. The ball then bounces with the lower boundary at point C and the opposite player fails to catch it at point D.

For the two steps in FIG. 17(a3), they have very similar screens with the screens in FIG. 17(a1), as the purple and yellow points are mixed in the same cluster in FIG. 18(a-b). However, they are the failed cases of the agent, as the trajectory shown in FIG. 18(g-h). At step 439, the agent was not able to adjust to a good paddle position and it failed to catch the ball at point E. At step 712, the agent caught the ball, but the angle/speed of the ball was not good enough for a kill-shot, and the agent was not ready for the ball bounced back from point G. Eventually, it lost it at point H. More playing strategies can be analyzed in the same way.

With the observation of different playing strategies, the next thing is to investigate how the agent derived these strategies, specifically, to determine the role of different RNN hidden/cell states. DRLxplore enables two manners to explore them: dimension-oriented and step-oriented.

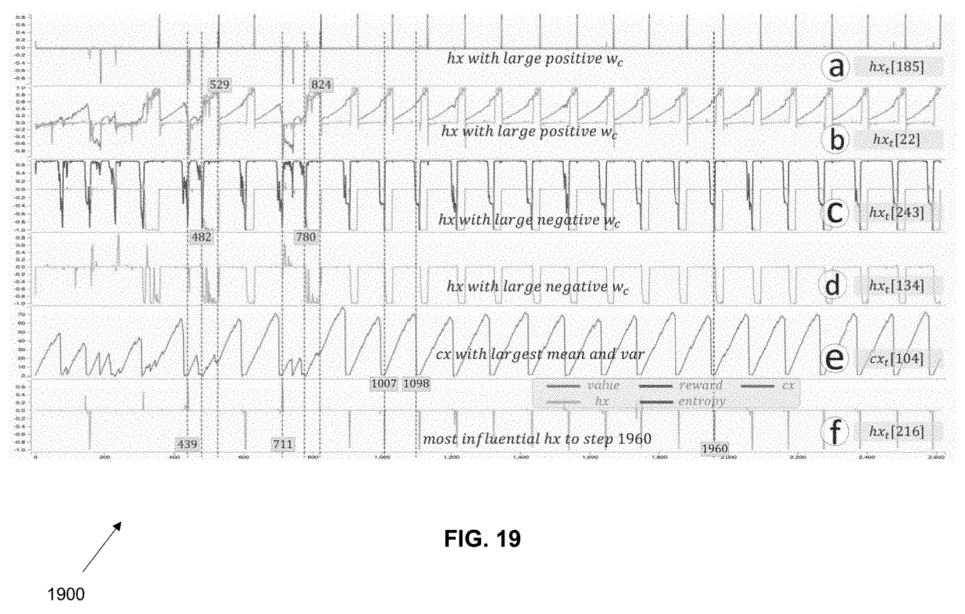

The dimension-oriented analysis allows users to sort the hidden/cell state dimensions based on different summary statistics aggregated over all steps (global statistics) to quickly identify the important dimensions. For example, in the Dimension view, the top row of rectangles can be sorted using wᵥ to get the most important dimension to the critic values. The dimension with the largest positive value is 185 (hxₜ [185], t ∈ [0, T]), its hidden state curve is shown in orange in FIG. 19(a). FIG. 19 shows a graphical user interface 1900 associated with dimension view according to some non-limiting embodiments or aspects. Most values of this dimension are close to 0, except the steps where the agent gains/loses points. As a result, this curve shows a big overlap with the reward curve (in green), except two steps: 529 and 824. From the entropy curve (in blue in FIG. 19(c)), the most confident action steps right before these two reward steps are step 482 and 780 respectively. The agent used the playing strategy demonstrated in FIGS. 17(a2), (d-e) in these two steps, which indicates that hxₜ[185] is not aware of the change to the critic values introduced by this playing strategy. The second dimension with the max wᵥ value is 22. It activates between the step of the smallest entropy and the reward step (FIG. 19(b)), which makes the critic values in this range large. For negative side, the dimension with the maximum negative w_{c} is 200. However, the hidden state of this dimension is mostly 0. So this dimension contributes little to the final critic value. The second dimension is 243 (orange curve in FIG. 19(c)). It shows negative correlation with dimension 22. Values of this dimension are mostly negative, and it has the same effect to dimension 22 after multiplying its negative weight wᵥ,

Sorting the hidden state dimensions based on the correlation between hx[i] and vᵢ allows us to verify the importance of dimension 22 and 143, as they are the most positively/negatively correlated with the value curve. More important dimensions can also be found from this sorting, such as dimension 134 (FIG. 19(d)), showing similar trend with dimension 243.

Similar analysis can also be extended to the cell states. For example, sorting cell states by the mean values, it was found that the dimension with the maximum mean is 104. This dimension works like a step counter (FIG. 19(e), see the vertical axis). It increases by ˜1 every step, and gets reset by the minimum entropy step in each periodical cycle.

The step-oriented analysis allows users to pick any single step and reorder dimensions based on the local statistics of that step only. In FIG. 19(f), step 1960 was picked, one of the most confident steps and the predicted action is fire (index 1). Therefore, there hidden state dimensions were reordered based on hx_{1960·w}_{¹}ₚ (as shown in the bottom row of FIG. 10(b1)). The top file most important dimensions are 57, 164, 216, 142, and 63. These five dimensions can be checked to further analyze the internal working mechanism of the agent. For example, FIG. 19(f) shows hxₜ[216]. This dimension has a very large negative value. However, since w¹ₚ[216] is also large and negative, their multiplications will be positive, which is the reason why it contributes significantly to hx_{1960·w}_{¹}ₚ. Step 439 and 711 of this dimension have abnormal positive values. They are the cluster in FIG. 17(a3). These two positive values multiplying the negative weight w¹ₚ make them contribute negative to hx₄₃₉. w¹ₚ and hx_{711·w}_{¹}ₚ. In return, the insufficient contribution from this dimension is probably the reason causing the failure cases in these two steps. This can be verified through interactive perturbation of DRLxplore.

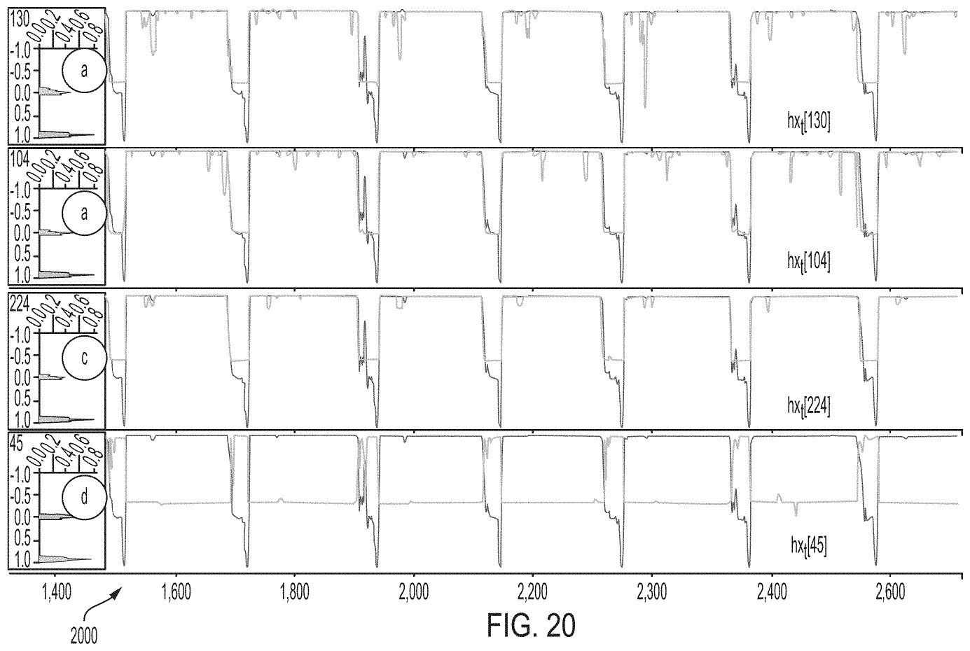

The step-oriented analysis can also be conducted by specifying two subsets of steps and select hidden/cell state dimensions based on the divergence between distributions formed in the two subsets. For example, FIG. 10(b2) selects two subsets of steps with low (gray brush) and high (red brush) entropies. The top four hidden state dimensions with the maximum JSD are 130, 104, 224, and 45. The corresponding hidden state curves are shown in FIG. 20, along with the entropy curve. FIG. 20 shows a graphical user interface 2000 associated with dimension view according to some non-limiting embodiments or aspects. From the visualization, the values of hxₜ[130] can be seen in the subset of steps with low/high entropies distributed around the value 0/1 respectively (the gray/red distribution in FIG. 20(a)). The clear distribution difference can also be found in dimension 104 and 224 (FIG. 20(b-c)). The values of dimension 45 are negatively correlated with these three dimensions (FIG. 20(d)).

There are also hidden state dimensions that learn nothing, indicating a higher-than-needed dimensionality of the hidden/cell states has been used. For example, after sorting the dimensions by variance, the values of dimension 199, 16, and 50 were found to be almost constant over the entire episode, indicating these dimensions are more than needed and learn nothing over the training.

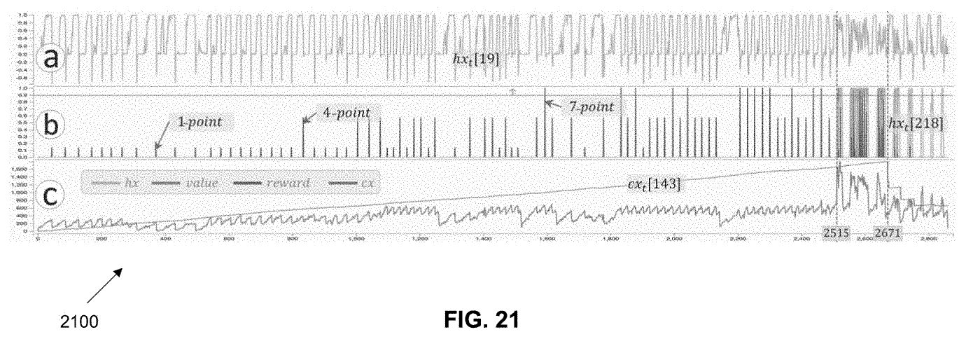

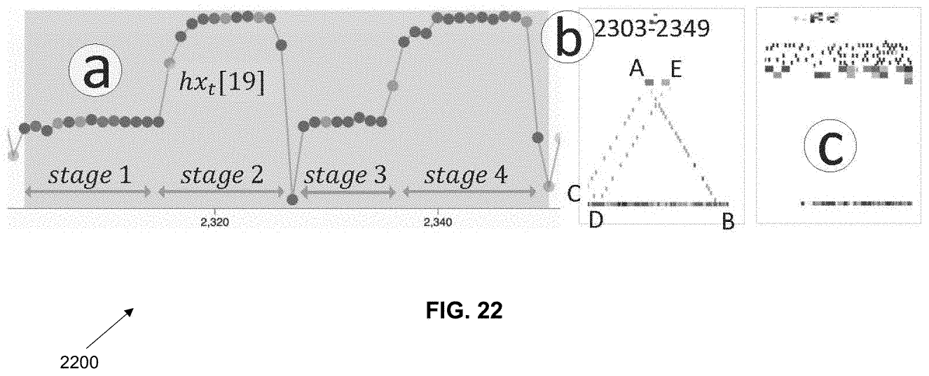

Hidden state dimensions that capture interpretable meaning from the Breakout game were also found. For example, FIG. 21(a) shows hxₜ[19] of the RNN model. FIG. 21 shows a graphical user interface 2100 associated with dimension view according to some non-limiting embodiments or aspects. The value of this dimension keeps around 0 when the ball flies toward the paddle, keeps around 1 when the ball flies toward the bricks, and becomes negative when the ball hits any bricks. FIG. 22 shows a graphical user interface 2200 of important hidden/cell state dimensions identified using dimension view according to some non-limiting embodiments or aspects. FIG. 22(a) shows a zoom-in view of this curve in step 2303-2349, which can roughly be cut into four stages. FIG. 22(b) shows the aggregated variance map in these steps. Stage 1 in FIG. 22(a) corresponds to the ball's move from point A to B. Stage 2 corresponds to B to A. The negative value of hxₜ [19] at the end of stage 2 is the step the ball hits the brick at position A and gets the reward, Stage 3 corresponds to the ball trajectory A-C-D, and stage 4 corresponds D-E. The negative value of hxₜ [19] at the end of stage 4 indicates another award step, where the ball hits bricks at position E. This curve keeps monitoring and memorizing the direction of the ball, and helps the agent prepare actions.

Dimension 218 (hxₜ[218]) is another interesting dimension (FIG. 21(b)). The value of this dimension keeps around 0, until around step 2515. Replaying the games in the Game-Replay view, step 2515 is when the agent dug a tunnel through all bricks. With this tunnel, the agent sent the ball through it and the ball can keep bounding between the top boundary and the bricks to receive rewards. A non-zero value of hxₜ[218] indicates the ball is above the bricks. As shown in FIG. 21(b), the thresholding line pointing-up can be used to select all steps whose hxₜ[218] value is above the threshold. The aggregated variance map is shown in FIG. 22(c). It can be seen that lots of bricks have been destroyed in these steps, and the ball is always above the bricks.

Some interesting dimensions can also be found from the cell states. For example, dimension 143 (cxₜ[143]) is a step counter that increases a constant amount every step until step 2671. This step counter is different from the step counter found in the Pong game (i.e., it does not reset every periodical cycle). The reason is probably because the game scene keeps changing, and there is no reappeared scene that can be used to identify periodical cycles.

Although 256 dimensions for the hidden/cell states was found to be more than enough in this case, some DRL models may use a much larger dimensionality for hidden/cell states. DRLxplore can be adapted well to RNN models with higher hidden/cell state dimensionality. Moreover, the capability of zooming in/out of the two rows of rectangles also help to mitigate potential scalability issues.

Although the interpretable semantics that the RNN cells captured are mostly game-specific in this example, the specific example reveals some general semantics across the games, which may also be relevant for other use cases. For example, both Pong and Breakout use a cell state dimension as a step counter to record the steps.

Therefore, DRLxplore is equipped with three coordinated views targeting to meet three practical needs from DRL experts, episode exploration, RNN hidden/cell state interpretation, and interactive perturbation. Through cases studies with the Atari games, it is presented how DRLxplore enables users to explore game episodes (and therefore other simulation scenarios), find interpretable RNN hidden/cell states, and interactively perturbing the RNN-based DRL model to verify the functionality of different components. With these studies, as well as the feedback from deep learning experts, the effectiveness of DRLxplore was validated.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment, and one or more steps may be taken in a different order than presented in the present disclosure.

1. A computer-implemented method for evaluating a recurrent neural network (RNN)-based deep learning model, comprising:
generating, with at least one processor, a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states;
generating, with the at least one processor, a second GUI comprising a point chart visually representing a two-dimensional projection of the multi-dimensional intermediate data, each point of the point chart representing a time step and at least one event from the time step based on multi-dimensional intermediate data between transformations in the RNN-based deep learning model that connect at least one state of the plurality of states to at least one event of the plurality of events; and
perturbing, with the at least one processor, the environment at a time step based on user interaction with at least one of the first GUI and the second GUI.

2. The computer-implemented method of claim 1, further comprising:
generating, with the at least one processor, a third GUI based on at least one hidden state and/or cell state of the RNN-based deep learning model.

3. The computer-implemented method of claim 2, further comprising:
identifying, with the at least one processor, a hidden state and/or cell state from the at least one hidden state and/or cell state impacting an event of the plurality of events.

4. The computer-implemented method of claim 2, wherein generating the third GUI comprises generating a visual representation of contrasted distributions over different subsets of a plurality of steps.

5. The computer-implemented method of claim 2, wherein generating the third GUI comprises generating at least two rows including a plurality of visual representations, each visual of the plurality of visual representations visualizing a hidden state and/or a cell state for one dimension of a plurality of dimensions of the model, wherein a first row of the at least two rows visually represents static global information of the plurality of steps, and wherein a second row of the at least two rows visually represents local information of a single step associated with the first GUI.

6. The computer-implemented method of claim 1, wherein the first GUI and second GUI comprise different windows within the same primary GUI.

7. The computer-implemented method of claim 1, further comprising:
updating, with the at least one processor, at least one of the first GUI and the second GUI based on output resulting from perturbing the environment.

8. The computer-implemented method of claim 1, further comprising:
determining at least one predicted rule generated by the RNN-based deep learning model based on data underlying the first and/or second GUI, wherein the at least one predicted rule comprises at least one condition and at least one predicted response to the at least one condition; and
verifying that the RNN-based deep learning model implements the at least one predicted rule by:
perturbing the environment based on the at least one condition; and
analyzing a response of the RNN-based deep learning model to the perturbation based on the at least one predicted response.

9. The computer-implemented method of claim 1, further comprising:
training, with the at least one processor, a second deep learning model using the RNN-based deep learning model.

10. The computer-implemented method of claim 1, wherein the environment comprises a simulator performing a simulated event, wherein the plurality of events and the plurality of states are associated with the simulated event.

11. The computer-implemented method of claim 10, wherein the simulated event comprises a simulated electronic payment fraud determination event.

12. The computer-implemented method of claim 11, wherein perturbing the environment comprises submitting a simulated electronic payment transaction to the RNN-based deep learning model.

13. The computer-implemented method of claim 1, wherein the environment comprises an electronic payment processing network, wherein the plurality of events comprise a plurality of transactions associated with transaction data, and wherein each state of the plurality of states comprises at least one of the following: a plurality of fraud determinations, a plurality of charge-backs, a plurality of cross-border transactions, or any combination thereof.

14. The computer-implemented method of claim 13, wherein the model data is generated based on historical transaction data, further comprising:
extracting at least one rule generated by the RNN-based deep learning model; and
applying the at least one rule to future transactions by a transaction processing system.

15. The computer-implemented method of claim 13, further comprising:
integrating the RNN-based deep learning model with a transaction processing system processing new transaction data associated with a new transaction by:
evaluating the new transaction data with the RNN-based deep learning model; and
determining the state of the new transaction with the RNN-based deep learning model.

16. The computer-implemented method of claim 15, further comprising:
denying the new transaction in response to determining the state of the new transaction to be a fraudulent state.

17. The computer-implemented method of claim 1, wherein the parameter value represents at least one effect of a plurality of effects or at least one state of the plurality of states.

18. The computer-implemented method of claim 1, wherein the RNN-based deep learning model is based on the plurality of states, the plurality of events, and a plurality of rewards associated with at least one state of the plurality of states and/or at least one event of the plurality of events.

19. A system for evaluating a recurrent neural network (RNN)-based deep learning model, comprising:
at least one data storage device comprising model data generated by a RNN-based deep learning model, the model data comprising a plurality of events associated with a plurality of states in an environment;
at least one processor in communication with the at least one data storage device, the at least one processor programmed or configured to:
generate a first graphical user interface (GUI) based on the model data comprising a chart visually representing a timeline for the plurality of events in relation to at least one parameter value based on the plurality of events and the plurality of states;
generate a second GUI comprising a point chart visually representing a two-dimensional projection of the multi-dimensional intermediate data, each point of the point chart representing a time step and at least one event from the time step, based on multi-dimensional intermediate data between transformations in the RNN-based deep learning model that connect at least one state of the plurality of states to at least one event of the plurality of events; and
perturb the environment at a time step based on user interaction with at least one of the first GUI and the second GUI.

20.-34. (canceled)

35. A computer program product for evaluating a recurrent neural network (RNN)-based deep learning model, comprising at least one non-transitory computer-readable medium including program instructions that, when executed by at least one processor, cause the at least one processor to:
generate a first graphical user interface (GUI) based on model data generated by a RNN-based deep learning model, the model data comprising a plurality of events associated with a plurality of states in an environment, the first GUI comprising a chart visually representing a timeline for the plurality of events in relation to at least one parameter value based on the plurality of events and the plurality of states;
generate a second GUI comprising a point chart visually representing a two-dimensional projection of the multi-dimensional intermediate data, each point of the point chart representing a time step and at least one event from the time step, based on multi-dimensional intermediate data between transformations in the RNN-based deep learning model that connect at least one state of the plurality of states to at least one event of the plurality of events; and
perturb the environment at a time step based on user interaction with at least one of the first GUI and the second GUI.
